(19) United States
(12) Patent Application Publication
(10) Pub. No.: US 2026/0362022 A1
(43) Pub. Date: Nov. 12, 2026

(54) IMAGE CAPTURE CONTROL APPARATUS AND IMAGE CAPTURE CONTROL METHOD, AND MULTI-CAMERA IMAGE CAPTURE SYSTEM

(71) Applicant: CANON KABUSHIKI KAISHA, Tokyo (JP)

(72) Inventor: KOYO SATO, Tokyo (JP)

(21) Appl. No.: 19/668,609

(22) Filed: May 5, 2026

(30) Foreign Application Priority Data
May 12, 2025 (JP) 2025-079854

(51) Int. Cl. H04N 23/90; H04N 23/58; H04N 23/60; H04N 25/47

(52) U.S. Cl. CPC H04N 23/90; H04N 23/58; H04N 23/64; H04N 25/47

(57) ABSTRACT

An image capture control apparatus that automatically controls a capture direction and/or a field of view for each of sub-cameras among cameras including a main camera and the sub-cameras, is disclosed. The apparatus detects information indicating that a scene change occurred in a video selected by an external apparatus from among videos output from the cameras, or that an operation for making a scene change in the selected video was started. Based on a detection result, the apparatus performs first control of the capture direction and/or the field of view of the sub-cameras based on a state of the main camera or a video output from the main camera or second control of the capture direction and/or the field of view of the sub-cameras not based on the state.

### BACKGROUND

### Field of the Technology

The present disclosure relates to an image capture control apparatus and an image capture control method, as well as to a multi-camera image capture system, and particularly relates to a technique for automatically controlling image capture operations of an image capture apparatus.

### Description of the Related Art

In live broadcasting and recording, a multi-camera image capture system is used which uses a video switch to dynamically select or switch the video to be used for livestreaming or recording (main video) from video captured simultaneously by a plurality of cameras, and outputs the selected video (Japanese Patent Laid-Open No. 2022-45529).

In such a multi-camera image capture system, for example, when the operations of one camera (a sub-camera) are to be coordinated with the operations of another camera (a main camera), appropriate coordination control is required.

### SUMMARY

The present disclosure in one aspect provides a coordination control technique for cameras in a multi-camera image capture system.

According to an aspect of the present disclosure, there is provided an image capture control apparatus that controls image capture operations of a plurality of sub-cameras among a plurality of cameras including a main camera and the plurality of sub-cameras, the image capture control apparatus comprising: one or more processors that execute a program stored in a memory and thereby cause the image capture control apparatus to: perform automatic control of one or both of a capture direction and a field of view for each of the plurality of sub-cameras; and detect information indicating that a scene change occurred in a video selected by an external apparatus from among videos output from the plurality of cameras, or that an operation for making a scene change in the selected video was started, wherein in the automatic control, based on a result of the detection, control is switched between: first control that automatically controls one or both of the capture direction and the field of view of the plurality of sub-cameras based on a state of the main camera or a video output from the main camera; and second control that automatically controls one or both of the capture direction and the field of view of the plurality of sub-cameras not based on the state of the main camera and the video output from the main camera.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an image capture system according to a first embodiment.

FIG. 2 is a block diagram illustrating an example of the functional configuration of each of apparatuses in the image capture system according to the first embodiment.

FIG. 3 is a diagram illustrating the image capture control apparatus according to the first embodiment, focusing on main operations and the flow of signals.

FIG. 4 is a diagram illustrating an example of the roles and control details that can be set for a sub-camera according to the first embodiment.

FIG. 5 is a flowchart pertaining to role determination processing according to the first embodiment.

FIGS. 6A to 6D are flowcharts pertaining to operations of each of the apparatuses of the image capture system according to the first embodiment.

FIGS. 7A and 7B are diagrams illustrating coordinate conversion according to the first embodiment.

FIGS. 8A and 8B are diagrams illustrating subject detection and coordinate conversion according to the first embodiment.

FIGS. 9A to 9C are schematic diagrams illustrating the control of operations of a sub-camera according to the first embodiment.

FIGS. 10A to 10C are schematic diagrams illustrating another example of the control of operations of a sub-camera according to the first embodiment.

FIG. 11 is a diagram illustrating pan value calculation according to the first embodiment.

FIG. 12 is a diagram illustrating tilt value calculation according to the first embodiment.

FIG. 13 is a diagram illustrating an example of the mapping of zoom values between a main camera and a sub-camera according to the first embodiment.

FIG. 14 is a flowchart pertaining to operations of an image capture control apparatus according to the first embodiment.

FIG. 15 is a timing chart illustrating an example of a coordination status according to a first embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Overview of Multi-Camera Image Capture System

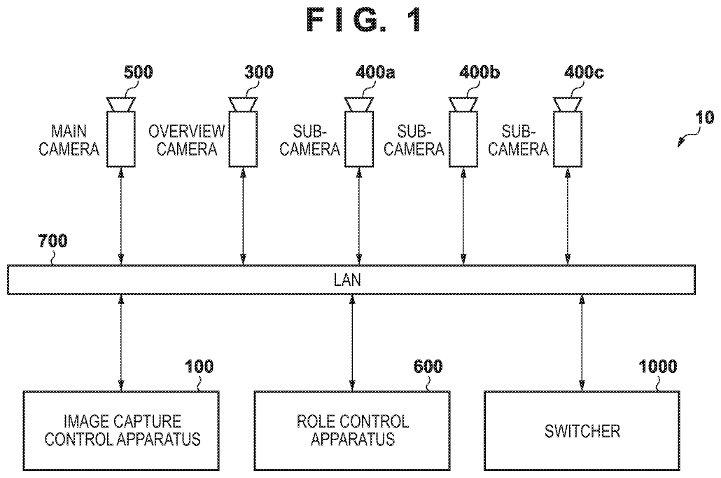

FIG. 1 is a schematic diagram illustrating an example of the configuration of a multi-camera image capture system 10 (called simply an “image capture system” hereinafter) according to the present embodiment. The image capture system 10 includes a plurality of cameras 300, 400a to 400c, and 500, an image capture control apparatus 100, a role control apparatus 600, and a video switcher 1000 (called simply a “switcher 1000” hereinafter). The plurality of cameras 300, 400a to 400c, and 500, the image capture control apparatus 100, the role control apparatus 600, and the switcher 1000 are communicably connected to each other over a communication network 700.

The communication network 700 is compliant with a publicly-known wired or wireless communication standard such as IEEE 802.3 series and the IEEE 802.11 series. Each of the plurality of cameras 300, 400a to 400c, and 500, as well as the image capture control apparatus 100, the role control apparatus 600, and the switcher 1000, have communication interfaces compliant with the standard used by the communication network 700.

Of the plurality of cameras 300, 400a to 400c, and 500, the camera 300 captures the entirety of a predetermined capture range. The capture range is set, for example, as a range in which a subject to be captured can be present, in a studio, for example. Accordingly, all subjects within the capture range are captured in video from the camera 300.

A purpose of the camera 300 is to capture video for detecting a subject to be captured (e.g., a person) present within the capture range. Accordingly, the capture direction and field of view of the camera 300 are determined in accordance with the position of the camera 300 and the capture range, and are basically fixed during capturing. The camera 300 also preferably captures the entirety of the capture range so as not to be hidden by objects outside the capture range. The camera 300 will be called an “overview camera” hereinafter to distinguish the camera 300 from the other cameras 400a to 400c and 500, in which the capture direction and field of view are basically not fixed during capturing. However, the installation position of the overview camera 300 is not limited to a location that provides an overview of the capture range. The operations of the overview camera 300 can be controlled from the image capture control apparatus 100.

The cameras 400a to 400c and 500 are PTZ cameras, for example, and operations including the capture direction (pan and tilt angles) and the field of view (zoom) can be controlled from an external apparatus. It is assumed here that the operations of the camera 500 are controlled by a user of the image capture system, and the operations of the cameras 400a to 400c are controlled by the image capture control apparatus 100. Because the image capture control apparatus 100 controls the operations of the cameras 400a to 400c based on the state of the camera 500, the camera 500 will be called a “main camera”, and the cameras 400a to 400c “sub-cameras”, hereinafter. To simplify the descriptions and facilitate understanding, FIG. 1 illustrates an example where three sub-cameras 400a to 400c are present, but the number of sub-cameras may be any non-zero number. The sub-cameras 400a to 400c will be collectively referred to as sub-cameras 400 hereinafter, and matters and operations common to the sub-cameras 400a to 400c will be described as matters and operations of the sub-cameras 400.

Note that the main camera 500 may be operated remotely from the image capture control apparatus 100 or another remote operation apparatus, by an operator or automatically, or directly operated by a photographer. The sub-cameras 400 and the main camera 500 may also be configured such that the capture direction (pan and tilt angles) can be controlled by mounting the camera bodies to pan-tilt heads. The sub-cameras 400 and the main camera 500 may also have configurations in which interchangeable lenses capable of zoom are attached to the camera bodies.

Here, the present embodiment assumes that the role control apparatus 600 and the switcher 1000 have an operator (a user). The image capture control apparatus 100 may also have an operator (a user), but this is not necessary. Additionally, the same user may operate two or more of the role control apparatus 600, the image capture control apparatus 100, and the switcher 1000. Because the image capturing by the overview camera 300 and the sub-cameras 400 is controlled by the image capture control apparatus 100, a photographer is not necessary. The main camera 500 is assumed to have an operator or a photographer. Using a configuration which does not require operators or photographers for several apparatuses in this manner can save labor.

Although FIG. 1 illustrates the communication network 700 in which all signals are communicated, it should be noted that video signals and control signals, for example, may be communicated using different methods. For example, each of the plurality of cameras 300, 400, and 500 may supply video signals directly to the image capture control apparatus 100 over a cable. The cameras 300, 400, and 500 and the image capture control apparatus 100 have communication circuitry compliant with the standard of the video signals. The standard of the video signals includes the Serial Digital Interface (SDI) standard, the High-Definition Multimedia Interface (HDMI) (registered trademark) standard, and the like, for example, but is not limited thereto.

The image capture control apparatus 100 detects a subject from the video signal received from the overview camera 300. The image capture control apparatus 100 also determines whether to automatically control the capture direction and field of view of each of the sub-cameras 400a to 400c in coordination with the main camera 500. The image capture control apparatus 100 determines the capture direction and field of view of the sub-cameras 400 for which the capture direction and field of view are to be controlled automatically in coordination with the main camera 500, based on roles that are set, subject detection results, and the state of the main camera 500. The image capture control apparatus 100 sends a control command including the determined capture direction and field of view to the target sub-cameras 400. By setting a role for each of the sub-cameras 400a to 400c, the methods for determining the capture direction and field of view of the sub-cameras 400 can be set individually, making it possible to increase the freedom of the control of the operations of the sub-cameras 400a to 400c.

### Functional Configuration of Each Apparatus

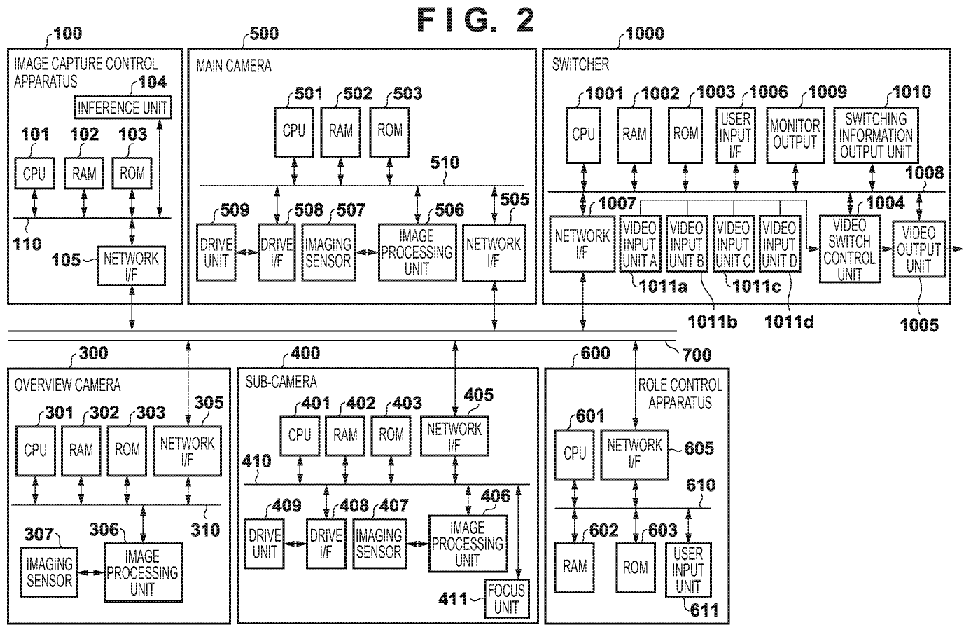

FIG. 2 is a block diagram illustrating an example of the functional configuration of each apparatus constituting the image capture system 10 illustrated in FIG. 1. However, the sub-cameras 400a to 400c are assumed to have the same configuration, and thus only one sub-camera 400 is illustrated in FIG. 2. Note also that the configurations illustrated in the drawings as function blocks may be realized by an integrated circuit such as an ASIC or an FPGA, by a discrete circuit, or by a combination of a memory and a processor executing a program stored in the memory. In addition, a single function block may be realized by a plurality of integrated circuit packages, or a plurality of function blocks may be realized by a single integrated circuit package. Additionally, the same function block may be implemented in different configurations in accordance with the operating environment, required capabilities, or the like.

### Image Capture Control Apparatus 100

An example of the functional configuration of the image capture control apparatus 100 will be described first. The image capture control apparatus 100 may be a general-purpose computer device such as a personal computer, a workstation, or the like. The image capture control apparatus 100 has a configuration in which a CPU 101, a RAM 102, a ROM 103, an inference unit 104, a network interface (I/F) 105, a user input unit 106, and a display unit 108 are connected to each other by an internal bus 110.

The CPU 101 is a microprocessor capable of executing programmed commands. The CPU 101 implements the functions of the image capture control apparatus 100 (described later) by, for example, loading programs stored in the ROM 103 into the RAM 102 and executing those programs. The CPU 101 can implement the functions of the image capture control apparatus 100 by, for example, executing an image capture control application that runs on basic software (an OS).

The RAM 102 is used for loading programs to be executed by the CPU 101, temporarily storing data to be processed and data being processed by the CPU 101, and the like. Note that part of the RAM 102 may also be used as a video memory for a display unit 108.

The ROM 103 is a rewritable non-volatile memory, and stores programs executed by the CPU 101 (the OS and applications), user data, and the like.

The inference unit 104 executes subject region detection processing on video from the overview camera 300 using a machine learning model. The inference unit 104 can implement the operations of the machine learning model using hardware circuits capable of high-speed execution, such as a graphics processing unit (GPU), a neural network processing unit (NPU), or the like, for example. Alternatively, the inference unit 104 may be implemented using a reconfigurable logic circuit such as a Field-Programmable Gate Array (FPGA). The functions of the inference unit 104 may be realized by the CPU 101 executing programs.

The machine learning model may be a convolutional neural network (CNN) trained in accordance with the type of the subject to be detected. It is assumed here that the inference unit 104 detects a human body region or a human face region from an input image as the subject region. For each detected subject region, the inference unit 104 outputs the position and size of a rectangular region that circumscribes the subject region, along with a detection reliability. Note that a plurality of types of machine learning models may be used to execute detection processing for different types of subject regions in the same input image. However, the inference unit 104 may perform the subject region detection processing through a publicly-known method that does not use a machine learning model. The inference unit 104 can detect a subject region using, for example, a method that uses local features, such as SIFT or SURF, a method that uses pattern matching, or the like.

The network I/F 105 is an interface for connecting the image capture control apparatus 100 to the communication network 700. The image capture control apparatus 100 (CPU 101) can communicate with external apparatuses on the communication network 700, such as the overview camera 300, the sub-cameras 400, the main camera 500, the role control apparatus 600, and the switcher 1000, through the network I/F 105. Note that the image capture control apparatus 100 may communicate with the external apparatuses through another type of communication interface (USB, Bluetooth (registered trademark), or the like; not shown).

The CPU 101 communicates with each apparatus on the communication network 700 (the overview camera 300, the sub-cameras 400, the main camera 500, the role control apparatus 600, and the switcher 1000). Accordingly, network addresses of those apparatuses are obtained at desired timings and stored in the RAM 102. The CPU 101 also obtains information about the apparatuses (the type, model name, and the like of each apparatus) at desired timings (e.g., at the time of initial communication) and stores that information in the RAM 102. In this manner, it is assumed that the CPU 101 knows at least identification information and the apparatus type for the overview camera 300, the sub-cameras 400, the main camera 500, the role control apparatus 600, and the switcher 1000. Note that the user may be able to assign desired names to individual apparatuses.

The user input unit 106 is an input device such as a mouse, a keyboard, a touch panel, or the like (not shown). The image capture control apparatus 100 accepts instructions from the user through the user input unit 106.

The display unit 108 is a display device such as a liquid crystal display (LCD). The display unit 108 displays GUI screens provided by the OS, the image capture control application, and the like.

### Overview Camera 300

An example of the functional configuration of the overview camera 300 will be described next.

A CPU 301 is a microprocessor capable of executing programmed commands. The CPU 301 implements the functions of the overview camera 300 (described later) by, for example, loading programs stored in a ROM 303 into a RAM 302 and executing the programs to control function blocks.

The RAM 302 is used for loading programs to be executed by the CPU 301, temporarily storing data to be processed and data currently being processed by the CPU 301, and the like. The RAM 302 may also be used as a buffer for captured video signals.

A ROM 308 is a rewritable non-volatile memory. The ROM 308 stores programs executed by the CPU 301, setting values for the overview camera 300, user data, and the like. Note that the ROM 308 can also be used as a location where video signals are recorded. The ROM 308 may include a built-in memory and a removable memory card.

An imaging sensor 307 includes an optical image capture system and an image sensor. The image sensor may be a publicly-known CCD or CMOS color image sensor having, for example, a primary color Bayer array color filter. The image sensor includes a pixel array, in which a plurality of pixels are arranged two-dimensionally, and peripheral circuitry for reading out signals from the pixels. Each pixel accumulates a charge corresponding to an amount of incident light through photoelectric conversion. By reading out, from each pixel, a signal having a voltage corresponding to the charge amount accumulated during an exposure period, a group of pixel signals (analog image signals) representing a subject image formed on the image capture surface is obtained.

An image processing unit 306 generates signals and image data for different purposes, obtains and/or generates various types of information, and the like by applying predetermined signal processing and image processing to the analog image signal output by the imaging sensor 307.

The processing applied by the image processing unit 306 can include preprocessing, color interpolation processing, correction processing, detection processing, data processing, evaluation value calculation processing, special effect processing, and the like, for example. The pre-processing includes signal amplification, A/D conversion, reference level adjustment, defective pixel correction, and the like. The color interpolation processing is performed when the imaging sensor 307 is provided with a color filter, and interpolates the values of color components that are not included in the individual pixel data constituting the image data. Color interpolation processing is also called “demosaicing”. The correction processing can include white balance adjustment, tone adjustment, correction of image degradation caused by optical aberrations of an image capture optical system (image restoration), correction of the effects of vignetting in the image capture optical system, color correction, and the like. The data processing can include cropping a region, combining, scaling, encoding and decoding, and header information generation (data file generation). The generation of video signals to be output to the exterior, video data recorded in the ROM 308, and the like is also included in the data processing. The evaluation value calculation processing can include processing such as generating signals, evaluation values, and the like used in automatic focus detection (AF), generating evaluation values used in automatic exposure control (AE), and the like. The AF and AE are executed by the CPU 301. The special effect processing includes adding bokeh effects, changing color tones, relighting processing, and the like. Note that these are examples of processing that can be applied by the image processing unit 306 and are not intended to limit the processing applied by the image processing unit 306. The image processing unit 306 outputs the obtained or generated information, data, and the like to the CPU 301, the RAM 302, or the like, according to the purpose of use.

Note that the types of processing and settings applied by the image processing unit 306 can be controlled by sending commands from the image capture control apparatus 100 to the overview camera 300.

A network I/F 305 is an interface for connecting the overview camera 300 to the communication network 700. The overview camera 300 (the CPU 301) can communicate with external apparatuses on the communication network 700, such as the image capture control apparatus 100, the sub-cameras 400, the main camera 500, and the role control apparatus 600, through the network I/F 305. Note that the overview camera 300 may communicate with the external apparatuses through another type of communication interface (USB, Bluetooth, or the like; not shown).

### Sub-Camera 400

An example of the functional configuration of the sub-camera 400 will be described next. It is assumed that function blocks having the same names as those in the sub-camera 400 and the overview camera 300 have the same functions, and descriptions thereof will therefore be omitted.

As described above, the sub-camera 400 is a PTZ camera, the capture direction and field of view of which can be controlled from the exterior. To that end, the sub-camera 400 includes a drive unit 409 capable of pan and tilt operations as well as zoom operations, and a drive I/F 408. The drive I/F 408 is a communication interface between the drive unit 409 and a CPU 401.

The drive unit 409 includes a pan/tilt mechanism that supports the sub-camera 400 to be capable of pan and tilt, a zoom mechanism that changes the field of view of an optical image capture system, motors that drive these mechanisms, and the like. As the zoom mechanism, the image may be enlarged or reduced by an image processing unit 406. The drive unit 409 drives the motors in accordance with instructions received from the CPU 401 through the drive I/F 408, and adjusts the optical axis direction (capture direction) and field of view of the optical image capture system.

### Main Camera 500

An example of the functional configuration of the main camera 500 will be described next. It is assumed that function blocks having the same names as those in the main camera 500 and the sub-camera 400 have the same functions, and descriptions thereof will therefore be omitted. The main camera 500 is operated by the user. It is assumed here that the user remotely operates the main camera 500 by sending commands over the communication network 700. However, when the main camera 500 is not a PTZ camera, for example, the photographer may operate the main camera 500 directly.

The image capture control apparatus 100 (the CPU 101) can obtain information on the capture direction and field of view of the sub-cameras 400 and the main camera 500 from the sub-cameras 400 and the main camera 500 through a network I/F 505. Note that the capture direction may be the pan and tilt angles of the drive units 409 and 509, with a predetermined reference direction set to 0°. The reference direction may be a direction corresponding to the capture range.

Note that the sub-cameras 400 and the main camera 500 include light-emitting members (lamps, LEDs, or the like) for performing a tally display. The tally display is a display indicating that the video being captured is being streamed or being previewed. The tally display may indicate that streaming is underway by lighting a red lamp and that previewing is underway by lighting a green lamp, for example, but the configuration is not limited thereto. The tally display can be implemented by the CPU 401 or 501 of a camera based on tally information supplied by the switcher 1000 through the network I/F 105. In this manner, the tally information, which is the control signal of the tally display, has the same information as camera state information STREAMING, and thus the tally information may be used instead of the camera state information STREAMING in the following descriptions.

### Role Control Apparatus 600

An example of the functional configuration of the role control apparatus 600 will be described next. A CPU 601 is a microprocessor capable of executing programmed commands. The CPU 601 implements the functions of the role control apparatus 600 by, for example, loading a role setting program stored in a ROM 603 into a RAM 602 and executing the program to control various function blocks.

The RAM 602 is used for loading programs to be executed by the CPU 601, temporarily storing data to be processed and data being processed by the CPU 601, and the like. Note that part of the RAM 602 may also be used as a video memory for a display unit 608.

The ROM 603 is a rewritable non-volatile memory, and stores programs to be executed by the CPU 601, setting values of the role control apparatus 600, user data, and the like.

A user input unit 611 is, for example, an input device such as buttons, dials, joysticks, a touch panel, or the like. The role control apparatus 600 accepts instructions from the user regarding the setting of the roles of the sub-cameras 400 through the user input unit 611.

A network I/F 605 is an interface for connecting the role control apparatus 600 to the communication network 700. The role control apparatus 600 (the CPU 601) can communicate with external apparatuses on the communication network 700, such as the overview camera 300, the sub-cameras 400, and the image capture control apparatus 100, through the network I/F 605. Note that the role control apparatus 600 may communicate with the external apparatuses through another type of communication interface (USB, Bluetooth, or the like; not shown).

The display unit 608 is a display device such as a liquid crystal display (LCD). The display unit 608 displays GUI screens provided by the OS, a role setting application, and the like.

The role control apparatus 600 stores role setting information in the ROM 603, for example. The role setting information is information in which identification information of the sub-cameras 400 and information indicating set roles are associated. The CPU 601 displays a role setting screen in the display unit 608 by executing the role setting application. For example, identification information of the sub-cameras 400 (the network addresses, names set by the user, and the like) is displayed in the role setting screen in association with the names of the roles currently set. The initial values of the roles currently set may be default roles set in advance. The user can change the current role displayed in association with a desired sub-camera 400 by operating the user input unit 611.

Upon detecting a user operation indicating the end of setting operations, such as the operation of an OK button included in the role setting screen, the CPU 601 updates the role setting information stored in the ROM 603 in accordance with the content of the role setting screen.

Upon receiving a role obtainment command through the network I/F 605, the CPU 601 reads out the role setting information stored in the ROM 603 and sends that information to the source of the role obtainment command.

Although FIGS. 1 and 2 illustrate the role control apparatus 600 as an independent apparatus, the image capture control application executed by the image capture control apparatus 100, for example, may provide the same functions as the role control apparatus 600. The roles may also be set directly for the sub-cameras 400, and the image capture control apparatus 100 may obtain the roles assigned to the sub-cameras 400 from the sub-cameras 400.

The roles that can be set for the sub-cameras 400 indicate, in advance, how information obtained from the main camera 500 is to be used to control the operations of the sub-cameras 400. Here, as one example, it is assumed that the information of the main camera is used to control tracked subjects and zoom operations of the sub-cameras 400.

### Switcher 1000

An example of the functional configuration of the switcher 1000 will be described next. The switcher 1000 includes a CPU 1001, a RAM 1002, a ROM 1003, a video switch control unit 1004, a video output unit 1005, a user input I/F 1006, and a network I/F 1007. The switcher 1000 further includes a monitor output unit 1009, a switching information output unit 1010, and a plurality of video input units 1011. An internal bus 1008 connects the various function blocks of the switcher 1000.

The CPU 1001 implements the functions of the switcher 1000 by, for example, loading programs stored in the ROM 1003 into the RAM 1002 and executing the programs to control the various function blocks.

The RAM 1002 is used for loading programs to be executed by the CPU 1001, temporarily storing data to be processed and data currently being processed by the CPU 1001, and the like. Part of the RAM 1002 may also be used as video memory for an external display device connected to the monitor output unit 1009, as a buffer for input video signals, and the like.

The ROM 1003 is a rewritable non-volatile memory, and stores programs executed by the CPU 1001, setting values of the switcher 1000, user data, and the like.

The video input units 1011 include four video input units A1011a, B1011b, C1011c, and D1011d. The four video input units 1011a to 1011d will be collectively referred to as “video input units 1011” hereinafter. In addition, descriptions of items A to D that overlap with reference signs a to d will be omitted.

The video input units 1011a to 1011d are interfaces for receiving images from the sub-cameras 400a to 400c and the main camera 500, respectively. The video input units 1011a to 1011d are configured as receivers compliant with standards such as Serial Digital Interface (SDI), High-Definition Multimedia Interface (HDMI) (registered trademark), and the like. In the present embodiment, four video input units 1011a to 1011d for receiving images from the sub-cameras 400a to 400c and the main camera 500 are provided, but the number of video input units 1011 may be any number of two or more.

Here, it is assumed that the video input unit 1011a receives video from the sub-camera 400a, the video input unit 1011b receives video from the sub-camera 400b, and the video input unit 1011c receives video from the sub-camera 400c. It is also assumed that the video input unit 1011d receives video from the main camera 500.

The video from the sub-cameras 400a to 400c and the main camera 500 may be input over the communication network 700 instead of being input to the video input units 1011a to 1011d. When the video is input over the communication network 700, the video sent by the sub-cameras 400 from the corresponding network I/Fs 405, the video sent by the main camera 500 from the network I/F 505, and the like is received from the network I/F 1007. Note that the video from the sub-cameras 400a to 400c and the main camera 500 may be a combination of video input to the video input units 1011 and video input from the network I/F 1007. Note also that five or more videos may be input over the communication network 700.

The video switch control unit 1004 outputs one of the plurality of videos input to the video input units 1011a to 1011d from the sub-cameras 400a to 400c and the main camera 500, respectively, to the video output unit 1005 (described later). The video switch control unit 1004 outputs a video selected through the user input I/F 1006 (described later). The video output by the video switch control unit 1004 is used for broadcasting, delivery, recording, and the like, for example, and will be referred to herein as “streamed video” for convenience, but may also be referred to as “main video”. Note that the video switch control unit 1004 is configured to select and output one of all the videos input to the switcher 1000 regardless of the input path.

The video output unit 1005 is an interface for outputting video output by the video switch control unit 1004 to a livestreaming device, a program recording device, or the like (not shown), and is constituted by a transmitter compliant with standards such as SDI, HDMI, or the like.

The user input I/F 1006 is, for example, an interface for connecting input devices such as buttons, dials, joysticks, touch panels, or the like (not shown). The switcher 1000 accepts instructions from the user regarding the selection of streamed video and preview video, the setting of the switcher 1000, and the like through the user input I/F 1006. The preview video is video that is scheduled as the next streamed video.

The CPU 1001 assigns information (state information) indicating whether the video being captured is streamed video IMG, preview video PRE, or the like to the cameras inputting the video that can be selected by the video switch control unit 1004 (state information). Specifically, the CPU 1001 determines that the state information of a camera capturing the video being output from the video output unit 1005 (the streamed video IMG) is “streaming”. The CPU 1001 determines that the state information of a camera capturing the preview video PRE is “previewing”. The CPU 1001 further determines that the state information of a camera capturing the remaining video is “standing by”. Note that herein, the camera capturing video may be referred to as the “source” of the video.

The CPU 1001 stores the state information in the RAM 1002 as camera state information STREAMING in association with the identification information of each camera. The identification information of the sub-cameras 400 may be any information capable of identifying the individual sub-cameras, such as a unique name provided by the user, a serial number, a network address, or the like. The CPU 1001 updates the camera state information STREAMING stored in the RAM 1002 each time the selection of the video signal is changed, for example. When the camera state information STREAMING stored in the RAM 1002 is updated, the CPU 1001 supplies the camera state information STREAMING to the image capture control apparatus 100 through the network I/F 1007 and the communication network 700. Upon receiving the camera state information STREAMING through the network I/F 105, the CPU 101 of the image capture control apparatus 100 saves that information in the RAM 102, or updates the camera state information STREAMING stored in the RAM 102.

The network I/F 1007 is an interface for connecting the switcher 1000 to the communication network 700. The switcher 1000 (the CPU 1001) can communicate with external apparatuses on the communication network 700, such as the overview camera 300, the sub-cameras 400a to 400c, the main camera 500, and the image capture control apparatus 100, through the network I/F 1007. Note that the switcher 1000 may communicate with the external apparatuses through another type of communication interface (USB, Bluetooth, or the like; not shown).

The monitor output unit 1009 generates video to display a list of the plurality of videos input to the switcher 1000 through the video input units 1011a to 1011d, the communication network 700, and the like. Additionally, the monitor output unit 1009 outputs the generated video to an external display device (not shown). The monitor output unit 1009 also outputs the data of the setting screen of the switcher 1000 to the external display device.

The switching information output unit 1010 generates scene change information SWITCHING upon detecting that a scene change has occurred or an operation for changing a scene has been started for the streamed video IMG output from the video output unit 1005. The scene change information SWITCHING is supplied to the image capture control apparatus 100 through the network I/F 1007 and the communication network 700. The CPU 101 of the image capture control apparatus 100 can detect the scene change information SWITCHING through the network I/F 105.

Here, a scene switch includes changing the source of the streamed video, i.e., the camera capturing the streamed video, and greatly changing the field of view, capture direction, and the like of the streamed video without changing the source thereof.

The switching information output unit 1010 can generate the scene change information SWITCHING in accordance with any of the following:
(a) an instruction to switch the streamed video IMG being detected through the user input I/F 1006;
(b) an event generated when the video switch control unit 1004 switches the streamed video IMG being detected;
(c) the application of a transition effect used to switch the source of the video, such as dissolving, a fade, or a wipe, being started;
(d) if the control signal (tally information) for a camera having state information of “streaming” or “previewing” to perform the tally display is being sent through the network I/F 1007, detecting a change in the tally information; and
(e) a scene change being detected based on the video output by the video output unit 1005.

Note that the conditions for generating the scene change information SWITCHING are not limited to the examples described here.

(a) to (d) are changes in the source of the streamed video. (e) is a major change in the field of view and the capture direction of the streamed video. Note that when the magnitude of an inter-frame difference is used in the detection of (e), a scene change can be considered to have occurred when the magnitude of the inter-frame difference exceeds a threshold. Note that if only the magnitude of the inter-frame difference is used, a scene change can be detected when the brightness of illumination has changed significantly due to the production, even if the field of view and the capture direction have not changed. Therefore, instead of or in addition to the inter-frame difference, the amount of change per frame or predetermined time period in the capture direction or field of view of the source of the streamed video exceeding a threshold may be used as a criterion for determining a scene change. The capture direction and field of view of the source can be obtained as information of the capture direction and the field of view of the source from the selected sub-camera, for example. The information of the control command (PT_VALUE, Z_VALUE, or the like) can be obtained from an external apparatus that controls the selected sub-camera (here, the image capture control apparatus 100), and thus the amount of change in the capture direction and the field of view of the sub-camera can be determined from the information. Accordingly, the current capture direction and field of view of the source can be obtained by applying an amount of change to the initial values of the capture direction and field of view of the sub-camera.

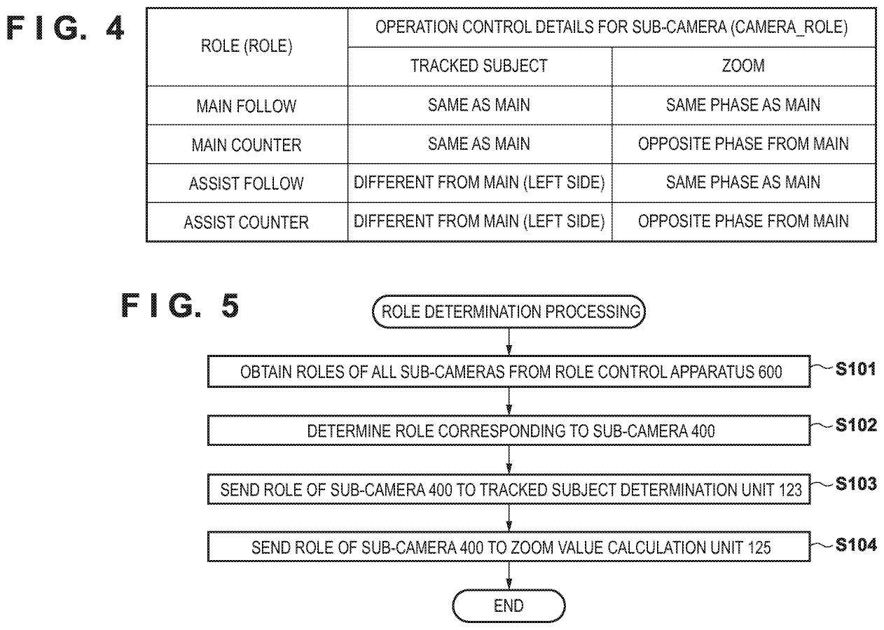

FIG. 4 illustrates an example of the type of roles that can be set for the sub-cameras 400 and control details associated with the roles. The control details for each role can be stored in the ROM 603 of the role control apparatus 600 and the ROM 103 of the image capture control apparatus 100 in the table format illustrated in FIG. 4, for example. Here, it is assumed that one of “main follow”, “main counter”, “assist follow”, and “assist counter” can be set as the role ROLE. When a plurality of sub-cameras 400 are present, roles can be set for each sub-camera.

For a sub-camera 400 having a role ROLE of “main follow”, the image capture control apparatus 100 (the CPU 101) sets the same tracked subject as the main camera 500, and controls the zoom such that when a zoom operation is made on the main camera 500, the sub-camera 400 zooms at the same phase. Here, “same phase” refers to the zoom direction (telephoto direction or wide-angle direction) being equal, i.e., the direction of change in the field of view being equal. On the other hand, “opposite phase” refers to the zoom direction (telephoto direction or wide-angle direction) being the opposite direction, i.e., the direction of change in the field of view being the opposite direction. Note that the field of view need not be equal to that of the main camera 500 even if the zoom direction is in the same phase, and the degree of change in the zoom (the speed, rate, and the like of the change) need not be equal to that of the main camera 500 in either the same phase or the opposite phase.

For a sub-camera 400 having a role ROLE of “main counter”, the image capture control apparatus 100 (the CPU 101) sets the same tracked subject as the main camera 500, and controls the zoom such that when a zoom operation is made on the main camera 500, the sub-camera 400 zooms at the opposite phase. Accordingly, when a zoom-in operation is made on the main camera 500, the image capture control apparatus 100 (the CPU 101) controls the sub-camera 400 having this role to zoom out. Note that “zooming in” refers to a change in zoom in the telephoto direction (toward the tele end), and “zooming out” refers to a change in zoom in the wide-angle direction (toward the wide end). When zoom control is performed by the image processing unit 406, “zooming in” refers to reducing the size of a cropped-out region and increasing the magnification of the cropped-out region to greater than before the region was changed. On the other hand, “zooming out” refers to enlarging the region cropped out from the image and reducing the magnification of the cropped-out region to less than before the region was changed.

For a sub-camera 400 having role ROLE of “assist follow”, the image capture control apparatus 100 (the CPU 101) sets a different tracked subject from the main camera 500, and controls the zoom such that when a zoom operation is made on the main camera 500, the sub-camera 400 zooms at the same phase.

For a sub-camera 400 having a role ROLE of “assist counter”, the image capture control apparatus 100 (the CPU 101) sets a different tracked subject from the main camera 500. In addition, when a zoom operation is made on the main camera 500, the image capture control apparatus 100 controls the zoom such that the sub-camera 400 zooms at the opposite phase.

Here, for a sub-camera 400 having a role ROLE of “assist follow” and “assist counter”, a subject is set in the image, among subjects different from a subject of interest of the main camera 500, that is present on the left side, as the tracked subject of the sub-camera 400. The tracked subject of the sub-camera 400 may be set according to different conditions. For example, a subject in the image that is different from the subject of interest of the main camera 500, and that is present on the right side, the upper side, or the lower side, may be the tracked subject of the sub-camera. Alternatively, a subject, among subjects different from the subject of interest of the main camera 500, that is present furthest to the front or the back may be set as the tracked subject of the sub-camera 400.

Furthermore, only one of the tracked subject settings and the zoom control may be executed, or another control item may be added as well.

In the role setting information stored by the role control apparatus 600 in the ROM 603, information indicating the role ROLE (such as the name of the types described above, or a number assigned to the type) is associated with the identification information of the sub-cameras 400. The CPU 101 of the image capture control apparatus 100 obtains the role setting information from the role control apparatus 600, and controls the operations of the sub-cameras 400 according to the types of the role ROLE set for the sub-cameras 400.

Note that if the role settings for the sub-cameras 400 have changed, the role control apparatus 600 may notify an external apparatus (e.g., the image capture control apparatus 100). This makes it possible to immediately reflect changes in the role settings in the control of operations of the sub-cameras 400.

### Operations of Each Apparatus

Operations performed by each apparatus in the multi-camera image capture system will be described next. The image capture control apparatus 100 automatically controls the image capture operations of the sub-cameras 400 based on the video from the overview camera 300, information obtained from the main camera 500, the camera state information STREAMING obtained from the switcher 1000, and the roles set for the sub-cameras 400.

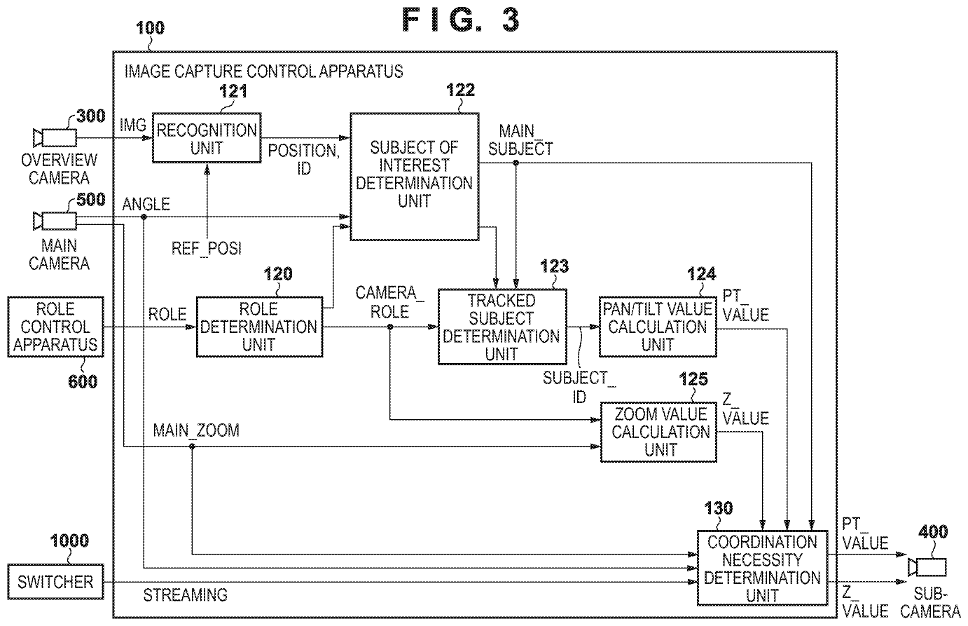

FIG. 3 is a diagram illustrating a series of processing performed by the image capture control apparatus 100 when controlling the operations of the sub-cameras 400, focusing on main operations and the flow of signals. Function blocks 120 to 125 and 130 within the image capture control apparatus 100 schematically indicate the main operations performed by the image capture control apparatus 100. In reality, the function blocks illustrated in FIG. 3 are realized by the CPU 101 executing the image capture control application and using one or more of the function blocks of the image capture control apparatus 100 illustrated in FIG. 2 as necessary.

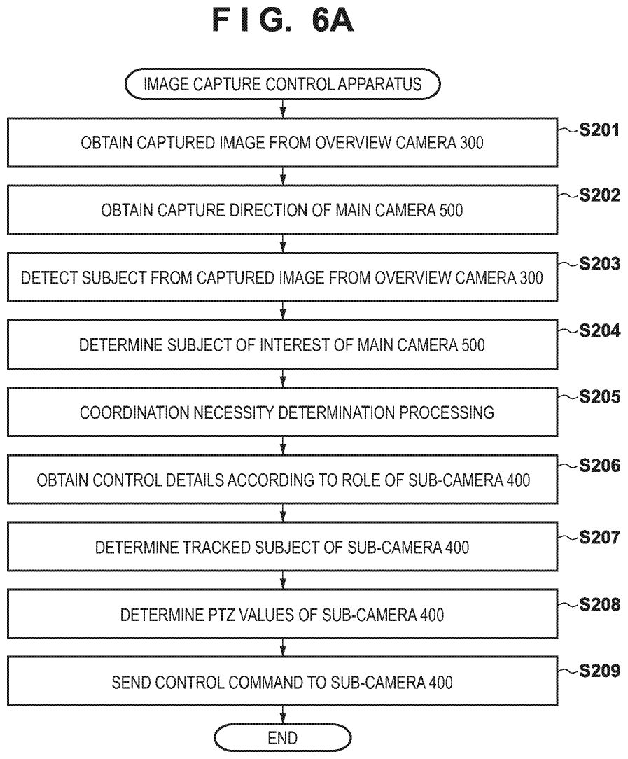

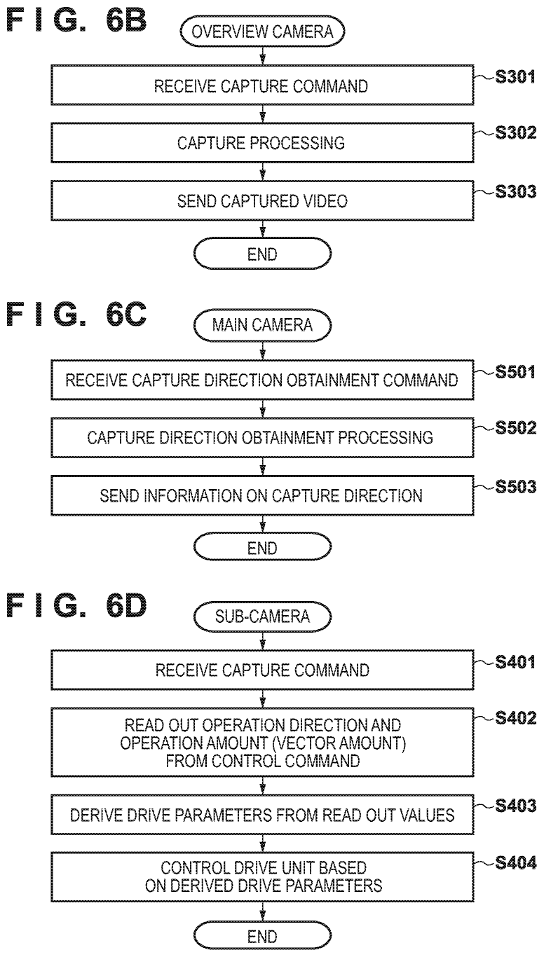

FIG. 5 is a flowchart illustrating operations performed by the CPU 101 functioning as a role determination unit 120. FIGS. 6A to 6D are flowcharts pertaining to operations of the image capture control apparatus 100, the overview camera 300, the main camera 500, and the sub-cameras 400, respectively.

The following descriptions assume that three-dimensional coordinates of a viewpoint position and the capture direction (the optical axis direction) of the overview camera 300 are known to the image capture control apparatus 100. It is also assumed that the three-dimensional coordinates of the viewpoint positions of the sub-cameras 400 and the main camera 500, the coordinates of marks arranged in the capture range, and the like are stored in the ROM 103 in advance as established position information REF_POSI. Note that the coordinate system of the position is assumed to be set in advance according to the type of the position.

### Operations of Role Determination Unit 120

Operations performed by the CPU 101 functioning as the role determination unit 120 in FIG. 3 will be described first with reference to the flowchart in FIG. 5. The operations described hereinafter are implemented by the CPU 101 executing the image capture control application.

Although the timing at which the procedure shown in the flowchart of FIG. 5 is started is not particularly limited, the procedure is executed at least before the control of the image capture operations by the sub-cameras 400 is started. It is also assumed that the procedure is executed when a notification from the role control apparatus 600 that the role setting for a sub-camera 400 has been changed is received by the network I/F 105 via the communication network 700.

In step S101, the CPU 101 functioning as the role determination unit 120 obtains the role ROLE (the role setting information) corresponding to the sub-cameras 400 from the role control apparatus 600. The CPU 101 functioning as the role determination unit 120 can obtain the above-described role setting information from the role control apparatus 600 by, for example, sending the role obtainment command from the network I/F 105 to the role control apparatus 600 over the communication network 700. The CPU 101 stores the obtained role setting information in the RAM 102.

In step S102, the CPU 101 functioning as the role determination unit 120 refers to the role setting information stored in the RAM 102 based on the identification information of the sub-cameras 400, and determines operation control details CAMERA_ROLE for the sub-cameras 400. Then, in step S103, the CPU 101 functioning as the role determination unit 120 sends the obtained operation control details CAMERA_ROLE to a tracked subject determination unit 123. In actuality, the CPU 101 stores the operation control details CAMERA_ROLE in a specific region of the RAM 102, and refers thereto when functioning as the tracked subject determination unit 123.

In step S104, the CPU 101 functioning as the role determination unit 120 sends the obtained operation control details CAMERA_ROLE to a zoom value calculation unit 125. In actuality, the CPU 101 stores the operation control details CAMERA_ROLE in a specific region of the RAM 102, and refers thereto when functioning as the zoom value calculation unit 125.

### Operations of Image Capture Control Apparatus 100

Operations performed by the image capture control apparatus 100 in controlling image capture by the sub-cameras 400 will be described next with reference to FIGS. 3 and 6A. The operations described hereinafter correspond to operations performed by the CPU 101 functioning as a recognition unit 121, a subject of interest determination unit 122, the tracked subject determination unit 123, a pan/tilt value calculation unit 124, and the zoom value calculation unit 125 in FIG. 3. Note that the operations described hereinafter are implemented by the CPU 101 executing the image capture control application.

In step S201, the CPU 101 sends a capture instruction command from the network I/F 105 to the overview camera 300 over the communication network 700 using a predetermined protocol. In response to this command, the overview camera 300 starts supplying a video signal (moving image data) IMG to the network I/F 105 over the communication network 700. The CPU 101 starts storing the video signal IMG received by the network I/F 105 in the RAM 102, and then executes step S202.

In step S202, the CPU 101 obtains information ANGLE, indicating the capture direction, from the main camera 500. Specifically, the CPU 101 sends a capture direction obtainment command from the network I/F 105 over the communication network 700 to the main camera 500 using a predetermined protocol. In response to the capture direction obtainment command, the CPU 501 of the main camera 500 sends the information ANGLE indicating the current capture direction of the main camera 500 to the image capture control apparatus 100. The information ANGLE may be pan and tilt angles of the drive unit 509, for example. The CPU 101 stores the obtained information ANGLE in the RAM 102.

In step S203, the recognition unit 121 executes the following processing.
(1) Applies subject region detection processing to an input frame image, and stores the detection result.
(2) Converts the coordinates of position information of the subject (image coordinates) for each detected subject region.
(3) Applies identification processing to each detected subject region and specifies the identification information (adds information for identification processing, for new subjects).
(4) Stores identification information ID[n] and position information POSITION[n] in association with each detected subject region.

The recognition unit 121 is implemented mainly by the CPU 101 and the inference unit 104. The CPU 101 reads out one frame of the video received from the overview camera 300 from the RAM 102 and inputs that frame to the inference unit 104.

The operations of the recognition unit 121 will be described in order hereinafter.

(1) First, the inference unit 104 inputs the frame image to the machine learning model and detects the subject region. The inference unit 104 stores a position and a size for each detected subject region output by the machine learning model as a detection result, as well as a detection reliability, in the RAM 102. The position and size of the subject region may be any information capable of specifying the position and size of a rectangular region that circumscribes the subject region. Here, the center coordinates of the lower side of the rectangular region, the width, and the height of the rectangular region are used as the position and size of the subject region.

The inference unit 104 also stores the detection result for the first frame image in the RAM 102 in association with the identification information ID[n] of the subject. Here, n is a number of the subject, and is an integer that takes a value from 1 to the total number of detected subject regions. The inference unit 104 further stores the subject region detected from the first frame image in the RAM 102 in association with the identification information ID[n] of the subject as a template for identifying individual subjects. The template need not be stored if template matching is not used to identify subjects.

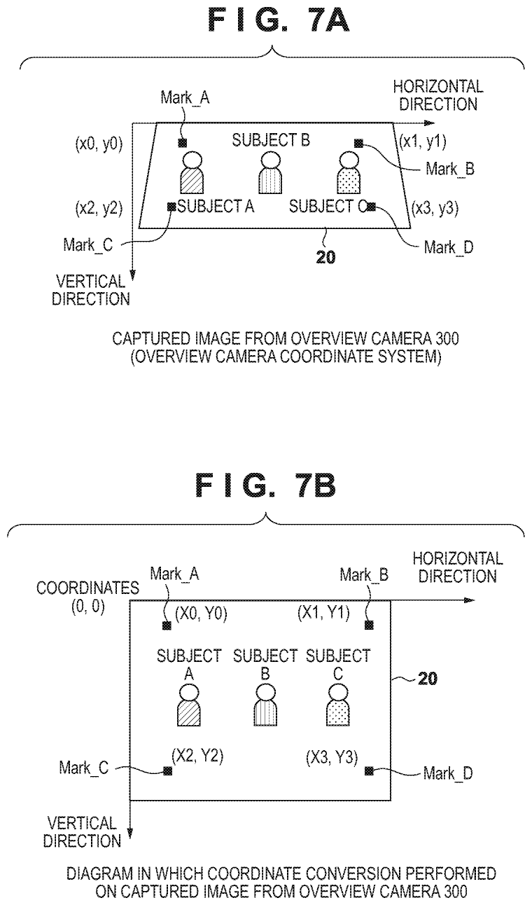

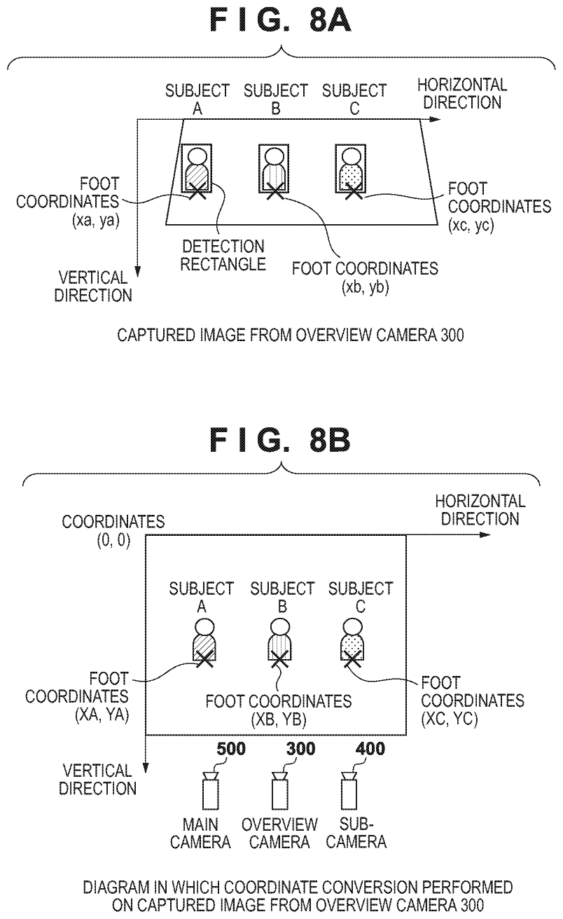

FIG. 8A illustrates an example of the result of the subject detection processing performed by the inference unit 104 with respect to the video from the overview camera 300 illustrated in FIG. 7A. Here, the regions of human subjects A to C present in a capture range 20 are detected, and the central coordinates of the lower sides of the rectangular regions that circumscribe the subject regions (foot coordinates) are output as positions.

As illustrated in FIG. 7B, for example, when marks are disposed at known positions within the capture range 20 for the coordinate conversion (described later), the CPU 101 detects images of the marks included in the frame image (FIG. 7A) and stores those positions in the RAM 102. The configuration may be such that detection of the mark images is also executed by the inference unit 104. The detection of the mark images can be performed through any publicly-known method, such as pattern matching using a mark template. The mark images may be detected using a machine learning model for mark detection stored in advance.

(2) The coordinate conversion executed by the inference unit 104 will be described next. FIG. 7A schematically illustrates the video from the overview camera 300, and FIG. 7B schematically illustrates a state in which the capture range 20 is viewed from directly above the center thereof. The inference unit 104 performs coordinate conversion on the position of the subject region in the coordinate system of the overview camera into values of a coordinate system used when viewing the capture range 20 from directly above the center thereof (a planar coordinate system).

Here, the coordinates are converted into values of the planar coordinate system to facilitate the calculation of the pan value (the angle of movement in the horizontal plane) for causing the sub-cameras 400 to capture a specific subject. Note that it is assumed here that the sub-cameras 400 are arranged such that the drive units 409 perform panning operations in a horizontal plane parallel to the floor of the capture range 20.

Although the coordinate conversion can be executed through a variety of methods, here, marks are arranged at a plurality of known positions on the floor of the capture range 20, and the coordinate conversion is performed from the overview camera coordinate system to the planar coordinate system based on the positions of the marks in the video obtained by the overview camera 300. Note that the coordinate conversion may be performed without using marks, such as using the viewpoint position and capture direction of the overview camera 300.

The coordinate conversion can be performed according to the following Formula 1 using a homography conversion matrix H.

$$( \begin{matrix}X \\ Y \\ W\end{matrix} ) = H ( \begin{matrix}x \\ y \\ 1\end{matrix} ) \qquad Formula 1$$

In Formula 1, x and y on the right side represent the horizontal and vertical coordinates in the overview camera coordinate system, and X and Y on the left side represent the horizontal and vertical coordinates of the planar coordinate system.

The homography conversion matrix can be calculated by assigning the coordinates of the four marks detected from the video and the (known) coordinates of the four marks arranged in the capture range 20 to Formula 1 and solving the simultaneous equations. If the positional relationship between the capture range 20 and the overview camera 300 is fixed, the homography conversion matrix H can be calculated in advance during a test capture, and saved in the ROM 103, for example.

The CPU 101 sequentially reads out the positions of the subject regions from the RAM 102 and converts those positions into values in the planar coordinate system. FIG. 8B schematically illustrates a state in which the foot coordinates (x,y) of each subject region detected in the overview camera 300 video illustrated in FIG. 8A are converted into coordinate values (X,Y) in the planar coordinate system using Formula 1 and the homography conversion matrix H saved in the ROM 103. The CPU 101 stores the converted foot coordinates in the RAM 102 as POSITION[n].

(3) Operations through which the inference unit 104 specifies the identification information ID[n] of the subject will be described next. It is assumed here that the subject is identified using template matching. The identification of the subject is performed on the second and subsequent subject detection processing results. The identification information ID[n] may be newly assigned to the subject region for the first processing result.

The inference unit 104 specifies the identification information ID[n] of the detected subject regions through template matching using a template stored in the RAM 102. The subjects within the capture range are identified as a result. For each detected subject region, the inference unit 104 calculates an evaluation value representing correlations of individual templates, for example. The inference unit 104 then specifies the identification information ID[n] corresponding to a template having at least a set correlation and having the highest correlation as the identification information ID[n] of the subject region. The evaluation value can use a publicly-known value, such as the sum of the absolute values of the differences in the pixel values, for example.

Note that the inference unit 104 assigns new identification information ID[n] to the subject regions that do not have at least a set correlation for all the templates, and adds images of the subject regions to the templates.

The inference unit 104 may also update existing templates using the subject regions detected in the most recent frame image, delete templates that do not have subject regions having at least a set correlation for a set period of time, and the like. The inference unit 104 may further store the template corresponding to identification information ID[n] that frequently occurs in the ROM 103.

Note that the subject may be identified through a method other than template matching. For example, the identification information ID[n] of a subject region may be identified as the same as that of an immediately detected subject region one or both of the position and size is closest. Furthermore, the position in the current frame image may be predicted using a Kalman filter or the like from a change in the position in a plurality of past detection results associated with the same identification information, and the same identification information ID may be specified in the subject region closest to the predicted position. The methods may also be combined. Not using template matching makes it possible to improve the identification accuracy of different subjects that look similar.

(4) The inference unit 104 associates the specified identification information ID[n] with the position (planar coordinate system) POSITION[n] of the corresponding subject region, and stores the information in the RAM 102.

Note that of the processing from (1) to (4), the processing other than subject detection may be executed by the CPU 101 instead of the inference unit 104.

Here, the identification information ID[n] and the position POSITION[n] pertaining to the subject in the capture range 20 are obtained using the video from the overview camera 300. However, the video from a sub-camera 400 may be used as well. When a plurality of sub-cameras 400 are present, the CPU 101 executes the operations described above for each sub-camera 400. The position of the subject region is output as values in the coordinate system of each of the sub-cameras 400. In this manner, the overview camera 300 is not required, but the accuracy of subject detection is thought to be better when the overview camera 300 is used.

Returning to the description of FIG. 6A, in step S204, the CPU 101, functioning as the subject of interest determination unit 122 illustrated in FIG. 3, determines a subject of interest as the tracked subject of the main camera 500. The CPU 101 can determine the subject of interest of the main camera 500 from among the subjects detected in step S203 based on the capture direction of the main camera 500 obtained in step S202. The CPU 101 stores the identification information ID[n] corresponding to the subject region determined as the subject of interest of the main camera 500 in the RAM 102 as identification information MAIN_SUBJECT of the subject of interest.

For example, the CPU 101 can determine that the subject closest to the capture direction of the main camera 500 in the planar coordinate system is the subject of interest of the main camera 500. Note that if a plurality of subjects at a distance from the capture direction of the main camera 500 that is less than or equal to a threshold are present, the user may be allowed to select the subject of interest from among the plurality of subjects.

When the user is allowed to select the subject of interest, the CPU 101 displays, on the display unit 108 or the external display device, the frame image to which the subject detection processing has been applied in step S202, along with an indicator indicating the capture direction and an indicator indicating a subject region that is a candidate for the subject of interest. The indicator of the subject region may be a rectangular frame indicating the outer edge of the subject region, such as that illustrated in FIG. 8A, or may be another indicator. The CPU 101 may also display a message, such as a prompt to select the subject of interest in the image, on the display unit 108.

The user can operate the user input unit 106 (input device) to select a subject region corresponding to the desired subject of interest. Although the selection method is not particularly limited, the method may be an operation for designating the desired subject region using a mouse or a keyboard.

Upon detecting the user operation for designating the subject region, the CPU 101 stores the identification information ID[n] corresponding to the designated subject region in the RAM 102 as the identification information MAIN_SUBJECT of the subject of interest.

In step S205, the CPU 101 functioning as a coordination necessity determination unit 130 executes coordination necessity determination processing. The coordination necessity determination processing is processing for determining whether to coordinate the sub-cameras 400 with the main camera 500, and will be described in detail later. The CPU 101 also saves, in the RAM 102, a coordination flag having a value corresponding to the result of the coordination necessity determination processing. The coordination flag is a flag indicating whether to coordinate the operations of the sub-cameras 400 with the operations of the main camera 500. The coordination flag takes a value of “on” (1) or “off” (0), and the default value is “on”. When a plurality of sub-cameras 400 are present, the coordination flags are the same for all sub-cameras.

If in step S205 it is determined that the sub-cameras 400 are to be coordinated with the main camera 500, the CPU 101 sets the coordination flags of the sub-cameras 400 stored in the RAM 102 to “on”, which is the default value. On the other hand, if it is determined that the cameras are not to be coordinated, the CPU 101 updates the coordination flags of the sub-cameras 400 stored in the RAM 102 to “off”.

Next, in step S206, the CPU 101 functioning as the tracked subject determination unit 123 illustrated in FIG. 3 obtains the operation control details CAMERA_ROLE according to the roles set for the sub-cameras 400. Specifically, the CPU 101 obtains the details through the role determination processing described with reference to FIG. 5, and reads out the operation control details CAMERA_ROLE stored in the RAM 102. When a plurality of sub-cameras 400 are present, the CPU 101 executes the processing of steps S206 to S209 for each sub-camera.

In step S207, the CPU 101 functioning as the tracked subject determination unit 123 determines a subject to be tracked and captured by the sub-camera 400. Even if the subject of interest of the main camera 500 changes, the CPU 101 does not change the tracked subject of the sub-camera 400 for all the sub-cameras 400 for which the value of the coordination flag is “off” and the sub-cameras 400 excluded from being subject to control due to the value of the coordination flag being “on”.

On the other hand, if the coordination flag is “on”, the CPU 101 determines the subject to be tracked and captured by the sub-camera 400 based on the subject of interest of the main camera 500, in accordance with the operation control details CAMERA_ROLE. The CPU 101 determines the tracked subject of the sub-camera 400 according to provisions of the tracked subject included in the operation control details CAMERA_ROLE (FIG. 4).

If the tracked subject of the sub-camera 400 is the same as the subject of interest of the main camera 500, the CPU 101 sets the identification information MAIN_SUBJECT of the subject of interest determined in step S203 as identification information SUBJECT_ID of the tracked subject of the sub-camera 400.

If the tracked subject of the sub-camera 400 is a subject, among subjects different from the subject of interest of the main camera 500, that is located on the left side, the CPU 101 detects the subject region, among the subject regions detected in step S203, that is located at the left end of the subject regions other than the subject of interest. The CPU 101 then sets the identification information ID[n] corresponding to the detected subject region as the identification information SUBJECT_ID of the tracked subject of the sub-camera 400.

The CPU 101 writes the determined identification information SUBJECT_ID of the tracked subject into the RAM 102. If the tracked subject can be different depending on the sub-camera, the CPU 101 stores the identification information SUBJECT_ID of the tracked subject in association with the identification information of the sub-camera. Note that if the tracked subject has changed, the CPU 101 holds the information of the previous tracked subject in the RAM 102 rather than clearing the information.

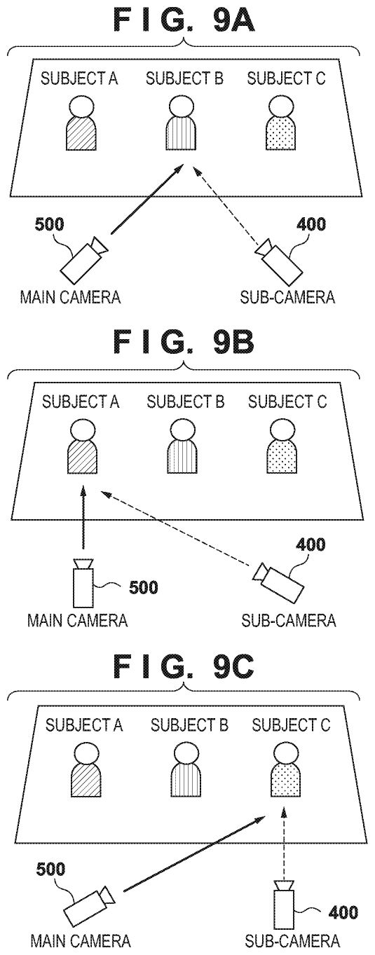

Operations performed when the role set for the sub-camera 400 is “main follow” will be described here with reference to FIGS. 9A to 9C. The image capture control apparatus 100 controls the sub-camera 400 for which the role “main follow” is set to track the subject of interest of the main camera 500.

Accordingly, as illustrated in FIG. 9A, if the subject of interest of the main camera 500 is determined to be a subject B, the CPU 101 determines that the subject B is the tracked subject of the sub-camera 400. Then, as illustrated in FIG. 9B, if the subject of interest of the main camera 500 is determined to have changed to a subject A, the CPU 101 changes the tracked subject of the sub-camera 400 to the subject A. Similarly, as illustrated in FIG. 9C, if the subject of interest of the main camera 500 is determined to have changed to a subject C, the CPU 101 changes the tracked subject of the sub-camera 400 to the subject C.

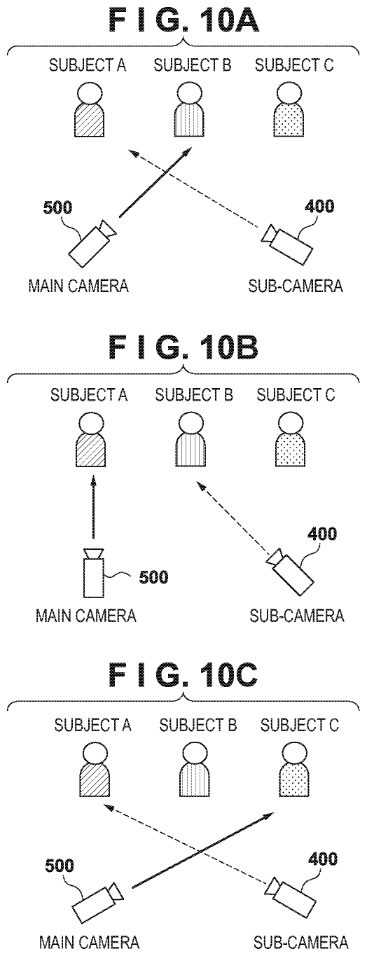

Operations performed when the role set for the sub-camera 400 is “assist follow” will be described here with reference to FIGS. 10A to 10C. The image capture control apparatus 100 controls a sub-camera 400 for which the role “assist follow” is set to track the subject, among the subjects different from the subject of interest of the main camera 500, located on the left side.

Accordingly, as illustrated in FIG. 10A, if the subject of interest of the main camera 500 is determined to be the subject B, the CPU 101 determines that among the subjects A and C, the subject A on the left is the tracked subject of the sub-camera 400. Then, as illustrated in FIG. 10B, if the subject of interest of the main camera 500 is determined to have changed to the subject A, the CPU 101 changes the tracked subject of the sub-camera 400 to the subject B, among the subjects B and C, which is on the left. Additionally, as illustrated in FIG. 10C, if the subject of interest of the main camera 500 is determined to have changed to the subject C, the CPU 101 changes the tracked subject of the sub-camera 400 to the subject A, among the subjects A and B, which is on the left.

By dynamically changing the roles set for the sub-cameras 400 by the role control apparatus 600, it is possible to change the tracked subjects of the sub-cameras 400, which enables flexible automatic capturing.

Returning to FIG. 6A, in step S208, the CPU 101 functioning as the pan/tilt value calculation unit 124 calculates an amount of change in the pan angle and the tilt angle necessary for the sub-camera 400 to track and capture the tracked subject determined in step S207. Additionally, the CPU 101 functioning as the zoom value calculation unit 125 calculates the zoom value of the sub-camera 400 in accordance with the change in the field of view of the main camera 500. Although a case where a single sub-camera 400 is used will be described hereinafter, when a plurality of sub-cameras 400 are used, the calculation of the amount of change in the pan angle and the tilt angle and the calculation of the zoom value are performed for each sub-camera.

Operations performed by the CPU 101 functioning as the pan/tilt value calculation unit 124 will be described first. It is assumed here that the following information is stored in the ROM 103 in advance as the established position information REF_POSI for each sub-camera 400.
Three-dimensional coordinates of the installation position (values in the planar coordinate system)
The capture direction corresponding to the initial values of the pan angle and the tilt angle of the drive unit
The controllable range of pan and tilt angles

The CPU 101 reads out position information POSITION_OH corresponding to the identification information SUBJECT_ID of the tracked subject of the sub-camera 400 from the RAM 102. Then, the CPU 101 first determines the pan angle from the position information POSITION_OH and the installation position of the sub-camera 400.

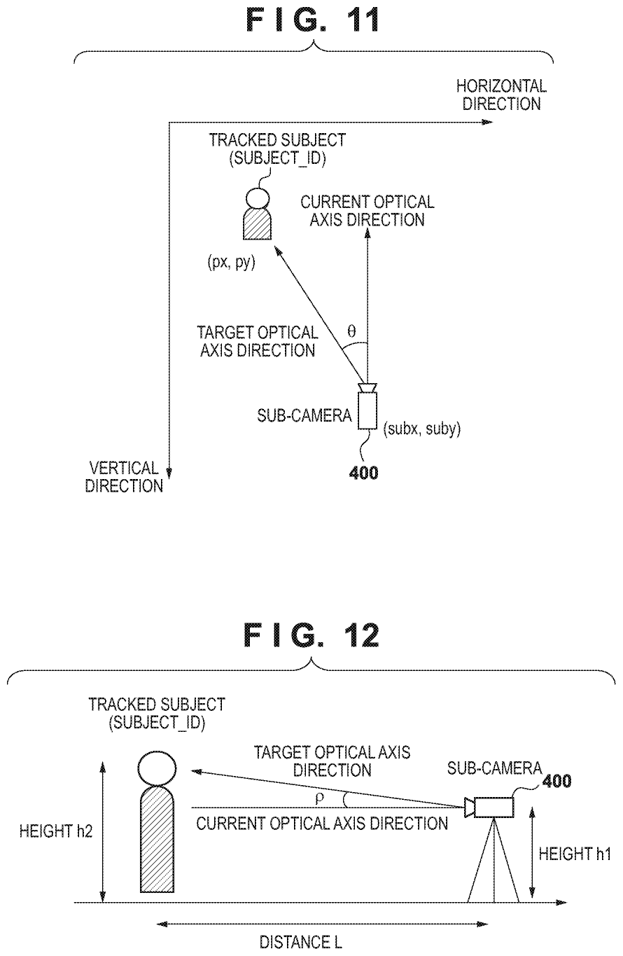

FIG. 11 is a diagram illustrating an example of a positional relationship between the sub-camera 400 and the tracked subject in the planar coordinate system. It is assumed that a pan angle θ at which the optical axis direction of the sub-camera 400 is oriented toward the subject position is to be determined here. The CPU 101 calculates the pan angle θ using the following Formula 2.

$$θ = {tan}^{- 1} \frac{px - subx}{py - suby} ( rad ) \qquad Formula 2$$

px and py in Formula 2 represent the horizontal and vertical coordinates of the position information POSITION_OH corresponding to the identification information SUBJECT_ID of the tracked subject. subx and suby represent the horizontal and vertical coordinates of the installation position of the sub-camera. It is assumed here that the current pan angle is an initial value of 0°, and the optical axis direction is the vertical direction (a Y-axis direction). If the current optical axis direction is not the vertical direction, the difference in angle between the current optical axis direction and the vertical direction may be reflected in the angle obtained from Formula 2. In addition, the pan direction is the counterclockwise direction when subx>px, and the clockwise direction when subx<px.

A method for determining the tilt angle will be described next with reference to FIG. 12. FIG. 12 illustrates a state in which the sub-camera and the tracked subject are viewed from the side. It is assumed that the current optical axis of the sub-camera 400 is aligned with the horizontal direction and the height thereof is h1, and that the height of the face of the tracked subject toward which the optical axis is oriented is h2. The angle difference in the height direction between the current optical axis direction and the target optical axis direction (tilt angle) is represented by p. The CPU 101 calculates the tilt angle ρ using the following Formulas 3 and 4.

$$L = \sqrt{{( px - subx )}^{2} + {( py - suby )}^{2}} \qquad Formula 3$$

$$ρ = {tan}^{- 1} \frac{h 2 - h 1}{L} ( rad ) \qquad Formula 4$$

The coordinate values used in Formula 4 are the same as the coordinate values used in Formula 2. h1 and h2 are assumed to be input to the image capture control application in advance and stored in the RAM 102. In this case, the identification number associated with h2 for each subject and the identification number assigned in the subject detection processing are set to be equal. Alternatively, h2 may use a value measured in real time using a sensor (not shown).

It is assumed here that the current tilt angle is the initial value of 0°, and the optical axis direction is the horizontal direction (the height is constant). If the current optical axis direction is not the horizontal direction, the difference in angle between the current optical axis direction and the horizontal direction may be reflected in the angle obtained from Formula 4. Additionally, the tilt direction is the downward direction if h1>h2, and the upward direction if h1<h2.

The CPU 101 periodically communicates with the sub-camera 400 over the communication network 700, obtains the current optical axis direction (the pan angle and the tilt angle of the drive unit), and stores that information in the RAM 102. Note that the communication period can be, for example, less than or equal to the inverse of the framerate. Alternatively, the CPU 101 may hold the total value of the pan angle and the tilt angle controlled from the initial state for the sub-camera 400 in the RAM 102 and use that total value as the current optical axis direction.

In this manner, the CPU 101 calculates the amount of change in the pan angle and the tilt angle of the sub-camera 400 and stores that amount in the RAM 102. When a plurality of sub-cameras 400 are present, the CPU 101 calculates the amount of change in the pan angle and the tilt angle for each sub-camera.

The amount of change in the pan angle and the tilt angle may be an angular velocity for the sub-camera 400 to rotate in the direction of the tracked subject. For example, the CPU 101 obtains the current pan angle and tilt angle from the sub-camera 400 over the communication network 700. The CPU 101 then finds the angular velocity for pan in proportion to the difference between the pan angle θ read out from the RAM 102 and the current pan angle. The CPU 101 also finds the angular velocity for tilt in proportion to the difference between the tilt angle ρ read out from the RAM 102 and the current tilt angle. The angular velocities calculated in this manner are stored in the RAM 102 by the CPU 101.

Note that the amount of change in the pan angle and the tilt angle may be calculated using the video from the sub-camera 400 instead of the video from the overview camera 300. In this case, the CPU 101 may calculate the amount of change in the pan angle from the difference, in the horizontal direction, between the current optical axis direction and the tracked subject direction in the coordinate system of the sub-camera 400, and calculate the amount of change in the tilt angle from the same difference in the vertical direction. Alternatively, the image capture system may change the capture direction for tracking and capturing the tracked subject in only one of the pan direction and the tilt direction, and in such an image capture system, only the amount of change in one of the pan angle and the tilt angle need be calculated.

Operations performed by the CPU 101 functioning as the zoom value calculation unit 125 will be described next. The CPU 101 functioning as the zoom value calculation unit 125 periodically obtains information MAIN_ZOOM indicating the field of view of the main camera 500, and stores that information in the RAM 102. When the information MAIN_ZOOM changes, the CPU 101 calculates a zoom value Z_VALUE for the sub-camera 400 in accordance with the operation control details CAMERA_ROLE based on the role set for the sub-camera 400. The format of the control command is assumed to be set in advance. The CPU 101 stores the generated control commands PT_VALUE and Z_VALUE in the RAM 102. Note that when the tracked subject is stationary, step S208 may be skipped if the field of view of the main camera 500 does not change or if there is no need to generate a control command. For the sub-camera 400, which is not coordinated with the main camera 500, the field of view control commands may be generated to maintain the size of the tracked subject, or the field of view may be fixed and a field of view control command may not be generated.

Note that the CPU 101 can determine the zoom operation of the main camera 500 and the phase thereof by, for example, detecting a change in the field of view of the video of the main camera 500. For example, a change in the field of view may be detected from a change in the size, interval, or the like of the subject region.

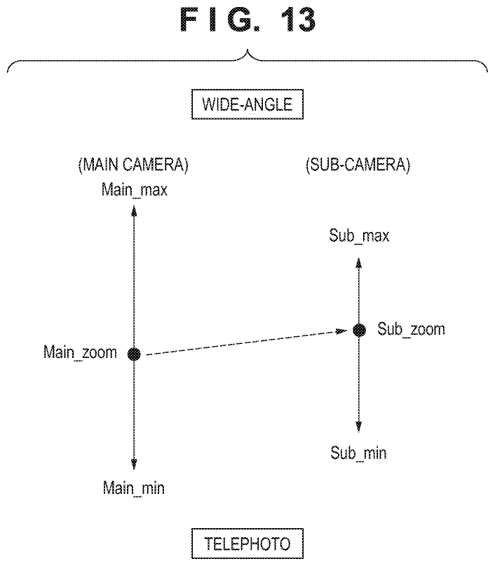

FIG. 13 illustrates an example of the mapping of zoom values of the main camera and the sub-camera. It is assumed here that the main camera 500 and the sub-camera 400 change the field of view optically (that the optical image capture system has a zoom function). However, the same function may be implemented by digital zooming using the image processing units 406 and 506.

Note that the zoom value is a parameter having a value corresponding to the field of view, and in the present embodiment, the smaller (narrower) the field of view is, the smaller the zoom value becomes, with the zoom value on the telephoto side being lower than the zoom value on the wide-angle side. It is assumed that the field of view of the respective imaging optical systems of the sub-camera 400 and the main camera 500 can be independently controlled to correspond to a zoom value by transmitting a command designating the zoom value to a respective camera. In other words, the zoom value is information pertaining to the field of view, and is information expressing the zoom state. The zoom value may be, for example, the focal length (mm) of an optical image capture system supporting a 35-mm full-size image sensor, in which case the zoom value on the telephoto side is greater than the zoom value on the wide-angle side.

In FIG. 13, the zoom value MAIN_ZOOM of the main camera 500 ranges from main_min to main_max. The zoom range of the sub-camera 400 is from sub_min to sub_max. main_min and sub_min are zoom values corresponding to the telephoto ends of the main camera 500 and the sub-camera 400, respectively, while main_max and sub_max are zoom values corresponding to the wide-angle ends of the main camera 500 and the sub-camera 400, respectively. FIG. 13 illustrates an example in which the zoom value range of the main camera 500 is broader than the zoom value range of the sub-camera 400 for both the telephoto end and the wide-angle end.

When a zoom value SUB_ZOOM of the sub-camera 400 is controlled to be in the same phase as the zoom value MAIN_ZOOM of the main camera 500, the CPU 101 calculates the SUB_ZOOM corresponding to the current MAIN_ZOOM using the following Formula 5.

$$SUB\_ZOOM = \frac{MAIN\_ZOOM - main\_min}{main\_max - main\_min} \times ( sub\_max - sub\_min ) \qquad Formula 5$$

On the other hand, when the zoom value SUB_ZOOM of the sub-camera 400 is controlled to be in the opposite phase from the zoom value MAIN_ZOOM of the main camera 500, the SUB_ZOOM corresponding to the current MAIN_ZOOM is calculated using the following Formula 6. Specifically, the CPU 101 calculates the SUB_ZOOM corresponding to the current MAIN_ZOOM by substituting the SUB_ZOOM calculated in Formula 5 on the right side of the following Formula 6.

SUB_ZOOM=sub_max−(SUB_ZOOM−sub_min) Formula 6

If the main camera 500 controls the field of view through digital zoom and cropping, the CPU 101 can determine the zoom value SUB_ZOOM of the sub-camera 400 in accordance with the size of the range cropped by the main camera 500. Specifically, the CPU 101 sets the zoom value SUB_ZOOM to be smaller (a higher magnification) as the size of the range cropped by the main camera 500 decreases, and sets the zoom value SUB_ZOOM to be larger (a lower magnification) as the size increases.

Furthermore, the content of the zoom control associated with the role of the sub-camera 400 is not limited to control in the same phase as or the opposite phase from the main camera 500. For example, a zoom operation independent from the change in the field of view of the main camera 500 may be associated with the role. For example, an auto-zoom operation may be associated with the role such that the size of the tracked subject is kept constant. The field of view of the sub-camera 400 may also be fixed to a specific field of view. Adding roles associated with such zoom control to the control details for each role indicated in FIG. 4, or changing the details of the zoom control for the roles indicated in FIG. 4, enables various types of zoom control for the sub-camera 400.

Returning to FIG. 6A, in step S209, the CPU 101 functioning as the coordination necessity determination unit 130 sends the control command generated in step S208 to the sub-camera 400. Here, the CPU 101 reads out the control commands PT_VALUE and Z_VALUE from the RAM 102 and sends those commands from the network I/F 105 to the sub-camera 400 over the communication network 700. The sub-camera 400 receives the control commands PT_VALUE and Z_VALUE from the network I/F 405 over the communication network 700.

The CPU 101 executes the processing from step S201 on the next frame image in the video from the overview camera 300. Note that the processing illustrated in FIG. 6A need not necessarily be executed every frame.

### Operations of Overview Camera 300

Operations performed by the overview camera 300 will be described next with reference to FIG. 6B. The operations described hereinafter are implemented by the CPU 301 executing programs.

When the overview camera 300 is powered on, each function block is initialized by the CPU 301, after which the overview camera 300 enters a capture standby state. In the capture standby state, the CPU 301 may start moving image capture processing for live view display, and output display image data generated by the image processing unit 306 to the image capture control apparatus 100 through the network I/F 305.

In the capture standby state, the CPU 301 stands by to receive a control command from the network I/F 305. Upon receiving a control command, the CPU 301 executes operations in accordance with the control command. Operations performed when a capture command has been received from the image capture control apparatus 100 as the control command will be described here.

In step S301, the CPU 301 receives the capture command sent from the image capture control apparatus 100 from the network I/F 305 over the communication network 700.

Note that capture parameters such as framerate, resolution, and the like may be specified in the capture command. Settings pertaining to the processing applied by the image processing unit 306 may be included as well.

In step S302, in response to receiving the capture command, the CPU 301 starts the moving image capture processing for supplying a moving image to the image capture control apparatus 100. In this moving image capture processing, a moving image is captured at a higher quality than that in the moving image capture processing for live view display. For example, one or both of the resolution and the capture framerate of the moving image is higher than that of the moving image for live view display. The image processing unit 306 applies processing to the image based on settings for moving images supplied to the image capture control apparatus 100. The image processing unit 306 sequentially stores the generated moving image data in the RAM 302.

In step S303, the CPU 301 reads out the moving image data from the RAM 302, and sends the moving image data from the network I/F 305 to the image capture control apparatus 100 over the communication network 700. The processing from capture to the supply of the moving image data is continued until a control command for stopping the capture is received.

### Operations of Main Camera 500

Operations of the main camera 500 will be described next with reference to FIG. 7C. The operations described hereinafter are implemented by the CPU 501 executing programs.

When the main camera 500 is powered on, each function block is initialized by the CPU 501, after which moving image capture processing for supplying a moving image to the image capture control apparatus 100 is started. The image processing unit 506 applies processing to the analog image signal obtained from an imaging sensor 507 based on settings for moving images supplied to the image capture control apparatus 100. The image processing unit 506 sequentially stores the generated moving image data in a RAM 502. The CPU 501 reads out the moving image data from the RAM 502, and supplies the moving image data from the network I/F 505 to the image capture control apparatus 100 over the communication network 700.

The CPU 501 stands by to receive a control command from the network I/F 505 while supplying the moving image data to the image capture control apparatus 100. Upon receiving a control command, the CPU 501 executes operations in accordance with the control command. Operations performed when a capture direction obtainment command has been received will be described here. Note that when the pan/tilt control command PT_VALUE and the zoom control command Z_VALUE are received, the CPU 501 drives the drive unit 509 in accordance with the commands.

In step S501, the CPU 501 receives the capture direction obtainment command from the network I/F 505 over the communication network 700. The CPU 501 stores the received capture direction obtainment command in the RAM 502.

In step S502, in response to receiving the capture direction obtainment command, the CPU 501 obtains the current pan angle and tilt angle from the drive unit 509 via a drive I/F 508, and stores that information in the RAM 502.

In step S503, the CPU 501 reads out the current pan angle and tilt angle from the RAM 502, and sends that information to the image capture control apparatus 100 from the network I/F 305 over the communication network 700 as the capture direction information ANGLE.

### Operations of Sub-Camera 400

Operations performed by the sub-camera 400 will be described next with reference to FIG. 6D. The operations described hereinafter are implemented by the CPU 401 executing programs.

When the sub-camera 400 is powered on, each function block is initialized by the CPU 401, after which moving image capture processing for supplying a moving image to the image capture control apparatus 100 is started. The image processing unit 406 applies processing to the analog image signal obtained from an imaging sensor 407 based on settings for moving images supplied to the image capture control apparatus 100. The image processing unit 406 sequentially stores the generated moving image data in a RAM 402. The CPU 401 reads out the moving image data from the RAM 402, and supplies the moving image data from the network I/F 405 to the image capture control apparatus 100 over the communication network 700.

The CPU 401 stands by to receive a control command from the network I/F 405 while supplying the moving image data to the image capture control apparatus 100. Upon receiving a control command, the CPU 401 executes operations in accordance with the control command. Operations performed when the pan/tilt control command PT_VALUE and the zoom control command Z_VALUE are received from the image capture control apparatus 100 will be described here.

In step S401, the CPU 401 receives one or both of the pan/tilt control command PT_VALUE and the zoom control command Z_VALUE sent from the image capture control apparatus 100 from the network I/F 405 over the communication network 700. The CPU 401 stores the received control command in the RAM 402.

In step S402, the CPU 401 reads out an operation direction and a corresponding operation amount from the control command stored in the RAM 402, and stores that information in the RAM 402. Here, in the case of the pan/tilt control command PT_VALUE, the operation direction is the direction of the pan and/or the tilt, and the operation amount is a target angle. In the case of the zoom control command Z_VALUE, the operation amount is the zoom value, and because the operation direction can be specified from the zoom value, the operation direction need not be read out and stored.

In step S403, the CPU 401 generates drive parameters of the drive unit 409 based on the operation direction and operation amount read out in step S402. The CPU 401 may obtain the drive parameters based on the combination of the operation direction and operation amount, using a table held in a ROM 403 in advance, for example. Note that when the operation amount is given as a target value (a target angle, zoom value, or the like), the CPU 401 obtains the drive parameters from the difference from the current value.

In step S404, the CPU 401 controls the drive unit 409 through the drive I/F 408 based on the drive parameters obtained in step S404. Through this, the drive unit 409 changes the capture direction of the sub-camera 400 to the operation direction and angle specified in the pan/tilt control command PT_VALUE. The drive unit 409 also changes the field of view of the optical image capture system to the zoom value specified by the zoom control command Z_VALUE.

### Coordination Necessity Determination Processing

The coordination necessity determination processing performed in step S205 of FIG. 6A will be described in detail next. In the coordination necessity determination processing, whether to coordinate the operations of the sub-camera 400 with the operations of the main camera 500 is determined based on the scene change information SWITCHING output by the switching information output unit 1010.

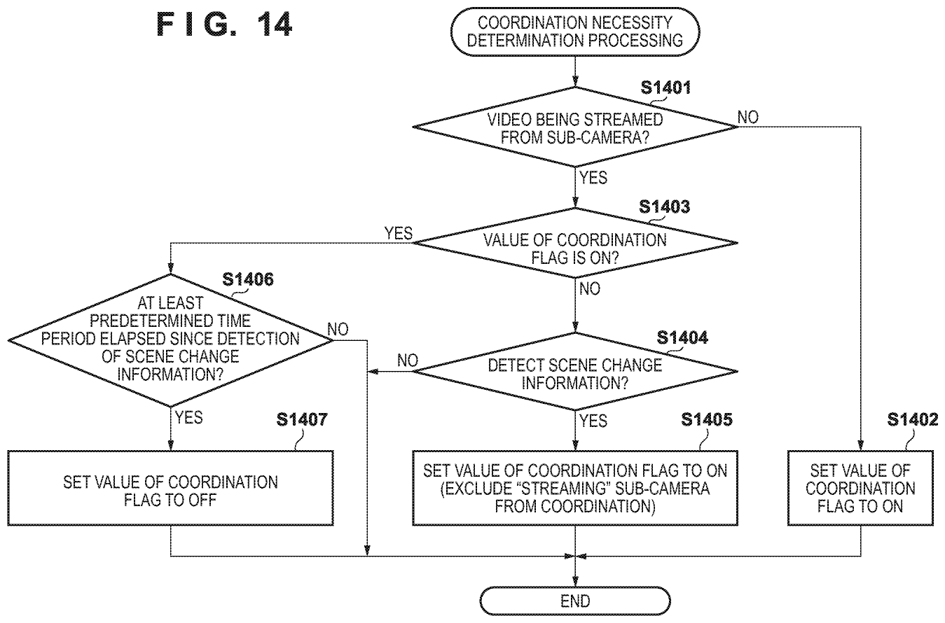

FIG. 14 is a flowchart pertaining to operations in the coordination necessity determination processing implemented by the CPU 101 functioning as the coordination necessity determination unit 130. In the present embodiment, basically, the image capture control apparatus 100 automatically controls the capture direction and field of view of the sub-camera 400 to be coordinated with changes in the capture direction and field of view of the main camera 500. However, if the switcher 1000 selects the video from the sub-camera 400 (if the streamed video is the video from the sub-camera 400), automatic control of the sub-camera 400 in coordination with the main camera 500 may be undesirable.

For example, if the streamed video is the video from the sub-camera 400, it may be possible for the user to greatly change the capture direction and field of view of the main camera 500 for a purpose such as finding the subject to be captured next. This is true not only when the photographer directly operates the main camera 500, but also when the photographer operates the main camera 500 remotely. If the sub-camera 400 is coordinated with the change in the capture direction and field of view of the main camera 500 in this manner when the video from the main camera 500 is not selected by the switcher 1000, the video of the sub-camera 400 selected by the switcher 1000 may be inappropriate for streaming.

Accordingly, if the streamed video is the video from the sub-camera 400, the stated problem can be avoided by setting the value of the coordination flag to “off” and stopping the automatic control of the sub-camera 400 in coordination with the operations of the main camera 500. On the other hand, because it is easy for the video from the sub-camera 400 to become monotonous while the coordination with the main camera 500 is stopped, it is desirable to keep the period for which the coordination is stopped to a minimum.

Based on this technical background, the CPU 101 functioning as the coordination necessity determination unit 130 executes the coordination necessity determination processing as follows.

In step S1401, the CPU 101 determines whether video is being streamed from any of the sub-cameras 400. Specifically, the CPU 101 reads out camera state information STREAMING for each of the sub-cameras 400 from the RAM 102, and determines whether camera state information of “streaming” is included. Note that the CPU 101 may obtain the camera state information STREAMING from the switcher 1000 in step S1401.

If the CPU 101 determines that camera state information of “streaming” is included, the video from the sub-camera 400 is being streamed, and thus step S1403 is executed. If the CPU 101 determines that camera state information of “streaming” is not included, step S1402 is executed. Note that if the camera state information of the main camera 500 is not “streaming”, the CPU 101 determines that the video from the sub-camera 400 is being streamed, and step S1402 may be executed.

In addition, as described above, instead of using the camera state information STREAMING, the CPU 101 may obtain and use the tally information that the switcher 1000 is supplying to the main camera 500 and the sub-camera 400 through the network I/F 1007.

Step S1402 is executed when the video from the main camera 500 is being streamed. In step S1402, the CPU 101 sets the value of the coordination flag stored in the RAM 102 to “on”, and the coordination necessity determination processing ends. As a result, the operations of all the sub-cameras 400 are controlled to be coordinated with the operations of the main camera 500 and in accordance with the roles set therefor.

In step S1403, the CPU 101 determines whether the value of the coordination flag stored in the RAM 102 is “on”, executes step S1406 if so, and executes step S1404 if not.

In step S1404, the CPU 101 determines whether scene change information SWITCHING has been detected, stores the current time in the RAM 102 if so, and executes step S1405 thereafter. If the CPU 101 does not determine that the scene change information SWITCHING is detected, the coordination necessity determination processing ends. As described above, the switching information output unit 1010 generates the scene change information SWITCHING upon detecting that a scene change has occurred in the streamed video or an operation for changing the scene has been started.

In step S1405, the CPU 101 sets the value of the coordination flag stored in the RAM 102 to “on”. The identification information of the sub-camera that is the source of the streamed video is stored in the RAM 102 as information of a sub-camera that is to be excluded from the coordination. The CPU 101 then ends the coordination necessity determination processing.

In step S1406, the CPU 101 determines whether at least a predetermined time period has elapsed since the scene change information was most recently detected, or since the execution of step S1405, and executes step S1407 if at least the predetermined time period is determined to have elapsed. The CPU 101 determines that at least the predetermined time period has elapsed if the difference between the current time and a time stored in the RAM 102 in step S1405 is at least a predetermined time period. If the CPU 101 does not determine that at least a predetermined time period has elapsed since the scene change information was most recently detected, the coordination necessity determination processing ends. The predetermined time period (e.g., about 10 to 60 seconds) is set in advance in accordance with the properties of the captured scene, for example. The user may be capable of setting the predetermined time period.

In step S1407, the CPU 101 sets the value of the coordination flag stored in the RAM 102 to “off”. The CPU 101 then ends the coordination necessity determination processing.

In this manner, in the present embodiment, when the streamed video is the video from the main camera 500, the operations of the sub-camera 400 are coordinated with the operations of the main camera 500. On the other hand, if the streamed video is the video from the sub-camera 400, the operations of sub-cameras other than the sub-camera that is the source of the streamed video are coordinated with the operations of the main camera 500 for a predetermined time period after scene change information is detected. Then, when a predetermined time period has elapsed after the scene change information was detected, the operation control coordinated with the operations of the main camera 500 is stopped for all of the sub-cameras 400.

Video in which the scene changes frequently is difficult to watch, and thus if the source of streamed video has been switched, it is unlikely that the source will be switched anew for a certain period of time thereafter. Furthermore, if the streamed video is switched from the video from the main camera to the video from the sub-camera, it is unlikely that the capture direction and field of view of the main camera will undergo a major change immediately.

Accordingly, until a predetermined time period has elapsed after the source is switched (after the scene change information is generated), operation control coordinated with the operation of the main camera is enabled for sub-cameras that are not the source of the streamed video, even if the streamed video is video from a sub-camera (first control). Then, once the predetermined time period has elapsed, it becomes more likely that the streamed video will be switched or the capture direction and field of view of the main camera will change greatly, and thus operation control coordinated with the operation of the main camera is disabled for all the sub-cameras (second control). Note that the state in which the operation control coordinated with the operation of the main camera is enabled may be maintained for sub-cameras other than the sub-camera that is the source of the streamed video even after the predetermined time period has elapsed. This corresponds to, for example, a case where continuing the coordination control is prioritized over reducing the number of candidates for sources that can be temporarily switched to due to a large change in the capture direction and field of view of the main camera. In this case too, the coordination control is disabled for the sub-camera that is the source of the streamed video, and thus the quality of the streamed video does not drop.

Such coordination control makes it possible to suppress a drop in the quality of the streamed video, the candidate for the video to be switched to, and the like, while increasing the time for which a variety of videos can be obtained from sub-cameras through the coordination with the main camera.

Note that a warning display may be performed by the image capture control apparatus 100 and the switcher 1000 to suppress major changes in the capture direction and field of view of the main camera 500, a switch in the source of the streamed video, and the like from when the scene change information is detected to when the predetermined time period passes.

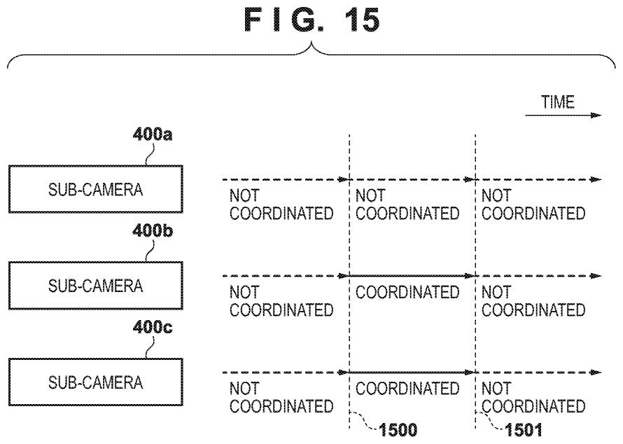

FIG. 15 is a diagram illustrating an example of coordination control of sub-cameras that is based on the coordination necessity determination processing according to the present embodiment. It is assumed here that the three sub-cameras 400a to 400c are present. The value of the coordination flag is assumed to be “off” in the initial state.

At time 1500, the source of the streamed video is switched from the sub-camera 400b or 400c to the sub-camera 400a, and the switching information SWITCHING is detected (step S1404, YES). In this case, in step S1405, the value of the coordination flag is set to “on”, and the sub-camera 400a, which is the source of the streamed video, is excluded from coordination.

As a result, the operation of the sub-cameras 400b and 400c, coordinated with the operation of the main camera 500, is enabled. On the other hand, for the sub-camera 400a excluded from the coordination, the coordinated operation with the operation of the main camera 500 is kept in a disabled state.

At a time 1501, after the predetermined time period has elapsed following time 1500, the coordination necessity determination processing transitions to steps S1401, S1403, S1406, and S1407, and the value of the coordination flag is set to “off”. As a result, the coordinated operation with the operation of the main camera 500 is disabled for all the sub-cameras 400a to 400c.

Note that when the value of the coordination flag is “on” in the initial state, the enabled or disabled state of the coordination control after time 1500 is the same.

As described above, according to the embodiment of the present disclosure, a coordination control technique for cameras in a multi-camera image capture system can be provided.

### Other Embodiments

In the foregoing embodiment, one coordination flag is used regardless of the number of sub-cameras 400. However, a coordination flag may be provided for each sub-camera. When a coordination flag is provided for each sub-camera, the values of the coordination flags are basically changed at once. However, in step S1405, the CPU 101 sets the value of the coordination flag of the sub-camera that is the source of the streamed video to “off”, and changes the values of the coordination flags of the other sub-cameras to “on”. In addition, in step S1407, the CPU 101 changes only the coordination flags having a value of “on” to “off” (the coordination flags may be set to “off” at once, including coordination flags having values of “off”).

Additionally, at least some of the operations related to control of the sub-cameras 400 described as being performed by the image capture control apparatus 100 (the CPU 101) in the foregoing embodiment may be performed by the individual sub-cameras 400 (the CPUs 401).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-079854, filed May 12, 2025, which is hereby incorporated by reference herein in its entirety.

What is claimed is:

1. An image capture control apparatus that controls image capture operations of a plurality of sub-cameras among a plurality of cameras including a main camera and the plurality of sub-cameras, the image capture control apparatus comprising:
one or more processors that execute a program stored in a memory and thereby cause the image capture control apparatus to:
perform automatic control of one or both of a capture direction and a field of view for each of the plurality of sub-cameras; and
detect information indicating that a scene change occurred in a video selected by an external apparatus from among videos output from the plurality of cameras, or that an operation for making a scene change in the selected video was started,
wherein in the automatic control, based on a result of the detection, control is switched between:
first control that automatically controls one or both of the capture direction and the field of view of the plurality of sub-cameras based on a state of the main camera or a video output from the main camera; and
second control that automatically controls one or both of the capture direction and the field of view of the plurality of sub-cameras not based on the state of the main camera and the video output from the main camera.

2. The image capture control apparatus according to claim 1,
wherein for the automatic control, whether the first control or the second control is to be performed is settable for each of the plurality of sub-cameras, and
in a case where the video output from any one of the plurality of sub-cameras is selected by the external apparatus, in the automatic control, the second control is performed for the sub-camera capturing the selected video.

3. The image capture control apparatus according to claim 1,
wherein in a case where the information is detected in a state where the video output by any one of the plurality of sub-cameras is selected by the external apparatus, in the automatic control, the first control is performed for one or more sub-cameras among the plurality of sub-cameras.

4. The image capture control apparatus according to claim 3,
wherein in a case where the information is detected in a state where the video output by any one of the plurality of sub-cameras is selected by the external apparatus, in the automatic control, the first control is performed for the one or more sub-cameras from when the information was most recently detected until elapse of a predetermined time period.

5. The image capture control apparatus according to claim 3,
wherein the one or more sub-cameras do not include a sub-camera capturing the video selected by the external apparatus, and
in the automatic control, the second control is performed for the sub-camera capturing the selected video.

6. The image capture control apparatus according to claim 4,
wherein in the automatic control, the second control is performed after elapse of the predetermined time period.

7. The image capture control apparatus according to claim 1,
wherein the scene change includes one or more of: a switch of the video selected by the external apparatus, a change in a field of view of the selected video, and a change in a capture direction of the selected video.

8. The image capture control apparatus according to claim 7,
wherein the scene change includes a switch of the video selected by the external apparatus, and
the information is generated in response to a user operation for switching the selected video.

9. The image capture control apparatus according to claim 7,
wherein the scene change includes a switch of the video selected by the external apparatus, and
the information is generated in response to a switch of the video selected by the external apparatus.

10. The image capture control apparatus according to claim 7,
wherein the scene change includes a switch of the video selected by the external apparatus, and
the information is generated in response to start of application of a transition effect in the video in the external apparatus.

11. The image capture control apparatus according to claim 7,
wherein the scene change includes a switch of the video selected by the external apparatus, and
the information is generated in response to a change in tally information supplied to the plurality of cameras by the external apparatus.

12. The image capture control apparatus according to claim 7,
wherein the scene change includes one or both of a change in the field of view of the selected video and a change in the capture direction of selected video, and
the information is generated in response to a magnitude of an inter-frame difference in the selected video exceeded a threshold.

13. The image capture control apparatus according to claim 1,
wherein in the automatic control, the first control is performed for each of the plurality of sub-cameras while the video output by the main camera is selected by the external apparatus.

14. A multi-camera image capture system comprising:
a plurality of cameras including a main camera and a plurality of sub-cameras;
a switching apparatus that selects one or videos output from the plurality of cameras; and
an image capture control apparatus that controls image capture operations of the plurality of sub-cameras,
wherein the image capture control apparatus comprises:
one or more processors that execute a program stored in a memory and thereby cause the image capture control apparatus to:
perform automatic control of one or both of a capture direction and a field of view for each of the plurality of sub-cameras; and
detect information indicating that a scene change occurred in a video selected by the switching apparatus from among videos output from the plurality of cameras, or that an operation for making a scene change in the selected video was started,
wherein in the automatic control, based on a result of the detection, control is switched between:
first control that automatically controls one or both of the capture direction and the field of view of the plurality of sub-cameras based on a state of the main camera or a video output from the main camera; and
second control that automatically controls one or both of the capture direction and the field of view of the plurality of sub-cameras not based on the state of the main camera and the video output from the main camera.

15. An image capture control method for controlling image capture operations of a plurality of sub-cameras among a plurality of cameras including a main camera and the plurality of sub-cameras, the image capture control method comprising:
automatically controlling one or both of a capture direction and a field of view for each of the plurality of sub-cameras; and
detecting information indicating that a scene change occurred in a video selected by an external apparatus from among videos output from the plurality of cameras, or that an operation for making a scene change in the selected video was started,
wherein in the automatic controlling, based on a result of the detecting, control is switched between:
first control that automatically controls one or both of the capture direction and the field of view of the plurality of sub-cameras based on a state of the main camera or a video output from the main camera; and
second control that automatically controls one or both of the capture direction and the field of view of the plurality of sub-cameras not based on the state of the main camera and the video output from the main camera.

16. A non-transitory computer-readable medium having stored therein a program for causing a computer to perform an image capture control method for controlling image capture operations of a plurality of sub-cameras among a plurality of cameras including a main camera and the plurality of sub-cameras, the image capture control method comprising:
automatically controlling one or both of a capture direction and a field of view for each of the plurality of sub-cameras; and
detecting information indicating that a scene change occurred in a video selected by an external apparatus from among videos output from the plurality of cameras, or that an operation for making a scene change in the selected video was started,
wherein in the automatic controlling, based on a result of the detecting, control is switched between:
first control that automatically controls one or both of the capture direction and the field of view of the plurality of sub-cameras based on a state of the main camera or a video output from the main camera; and
second control that automatically controls one or both of the capture direction and the field of view of the plurality of sub-cameras not based on the state of the main camera and the video output from the main camera.
